(19) United States
(12) Patent Application Publication
(10) Pub. No.: US 2025/0202655 A1
(43) Pub. Date: Jun. 19, 2025

(54) UPLINK BEAMFORMING FRAMEWORK FOR ADVANCED 5G NETWORKS

(71) Applicant: KONINKLIJKE PHILIPS N.V., EINDHOVEN (NL)

(72) Inventors: Marcus Grossmann, Erlangen (DE); Sutharshun Varatharaajan, Erlangen (DE)

(21) Appl. No.: 19/001,642

(22) Filed: Dec. 26, 2024

Related U.S. Application Data
(63) Continuation of application No. 17/635,150, filed on Feb. 14, 2022.

(51) Int. Cl. H04L 5/00; H04W 52/24

(52) U.S. Cl. CPC H04L 5/0051; H04W 52/242

(57) ABSTRACT

The present disclosure relates to methods and apparatuses suitable for an uplink beamforming framework for advanced radio technologies such as 5G. The method performed by a UE comprises: receiving (2001), from a network node, via a higher layer, a configuration of an Information element (IE) comprising a set of parameters used for the configuration of an UL beam direction or a spatial filter to be used in a UL transmission; wherein the IE contains at least: an ID unique to each IE and an ID of an UL reference signal, RS resource or a DL RS resource; and applying (2002) the UL beam direction or spatial filter IE for the transmission of one or more of the PUSCH, PUCCH resource(s) and/or Sounding Reference Signal, SRS resource(s).

### CROSS-REFERENCE TO PRIOR APPLICATIONS

This application is a continuation of U.S. patent application Ser. No. 17/635,150 filed on Feb. 14, 2022 which is the U.S. National Phase application under 35 U.S.C. § 371 of International Application No. PCT/EP2019/071964 filed on Aug. 15, 201920/050003 filed on Jan. 2, 2020. These applications are hereby incorporated by reference herein.

### TECHNICAL FIELD

The present disclosure relates to the field of wireless communications, and in particular to methods and apparatuses for uplink beam management and power control in a wireless network suitable for 5G.

### BACKGROUND

In millimeter wave (mmWave) frequencies (frequency range 2 (FR2)), i.e., frequencies above 6 GHZ, in general, wireless communication between communication devices is performed with spatially selective/directive transmissions and receptions called beams. Therefore, beam management is a required framework for link establishment, adaptation and recovery at FR2.

In the Third Generation Partnership Project Release 15, (3GPP Rel. 15) [1-6], beam management in uplink (UL) is handled separately for various UL channels and UL reference signals. The functionalities of the UL beam management framework are spread over three communication layers—the physical (PHY) layer [1-4], the medium access control (MAC) layer [5] and the Radio Resource Control (RRC) layer [6]. In order to enable a beamformed uplink transmission between a User Equipment (UE) and a radio network node (gNB), the beam management performs two tasks: Indication of the beam direction for the UL transmission, and indication of the transmit power settings associated with it. The two tasks are handled in different ways for the physical uplink shared channel (PUSCH), the physical uplink control channel (PUCCH) and the sounding reference signal (SRS).

On the other hand, in the downlink (DL), the UE must be given directives to derive various parameters such as delay spread, average delay, Doppler and Rx beam direction for the reception of a DL channel or reference signal (RS).

In the following, a brief description of indicating DL transmissions to the UE in 3GPP Rel. 15 is provided. It is followed by an overview of the UL channels and reference signals (RSs) and the corresponding beam configurations and indication mechanisms for the same used in 3GPP Rel. 15. These descriptions of the state of the art (SoTA) lead to the discussion on the inadequacies in UL beam direction and power control indication and configuration mechanisms in 3GPP Rel. 15 that provide the motivation for the present invention.

The term ‘beam’ is used in the following to denote a spatially selective/directive transmission or reception which is achieved by precoding and filtering the outgoing or incoming signal, respectively, at the antenna ports of the device with a particular set of coefficients. The set of coefficients used to spatially direct a transmission/reception in a certain direction may differ from one direction to another direction. The term ‘Tx beam’ denotes a spatially selective/directive transmission and the term ‘Rx beam’ denotes a spatially selective/directive reception. The set of coefficients used to precode/filter the transmission or reception is denoted by the term ‘spatial filter’. The term ‘spatial filter’ is used interchangeably with the term ‘beam direction’ in this disclosure as the spatial filter coefficients determine the direction in which a transmission/reception is spatially directed to.

### 1.1 Downlink Transmission Configuration Indication

The physical downlink control channel (PDCCH) and the physical downlink shared channel (PDSCH) carry DL control information and DL data, respectively, to a UE [1-6].

The PDCCH is configured at the Radio Resource Control (RRC) layer level by a base station or a network node or gNodeB (gNB). The gNB transmits the PDCCH(s) on one or more Control Resource Sets (CORESETs) that are configured at RRC level. A CORESET is a set of resource blocks carrying control information. Each CORESET comprises one or more PDCCH(s), each linked to a search space configuration. A PDCCH is either part of a common search space (CSS) or a UE-specific search space (USS). PDCCHs belonging to the CSS usually contain information that is broadcast by the gNB to all UEs, like system information broadcast or paging information. The PDCCHs belonging to a USS contain UE specific information, such as the downlink control information (DCI) to schedule a PDSCH or PUSCH or SRS trigger, etc.

Demodulation Reference Signals (DMRS) are embedded for the coherent demodulation of the PDCCH/PDSCH at the UE. The DMRS consists of a set of DMRS ports. The number of DMRS ports determines the number of transmission layers contained in a PDSCH. DMRS is used for channel estimation at the UE to coherently demodulate the PDSCH or PDCCH(s). In the case of PDCCH, one or more of them may be transmitted on a CORESET. Therefore, the DMRS for the coherent demodulation of the PDCCH(s) on the CORESET may be embedded across the PDCCH(s) transmitted on the CORESET.

An important parameter in the transmission of the PDCCH and the PDSCH is the ‘Transmission Configuration Indication’-state (TCI-state) [4]. In 3GPP Rel. 15, the indication of how the control or the shared channel is transmitted by the gNB and what assumptions the UE must consider while receiving them is done via reference signals (RSs). The indication to the UE is performed using a TCI-state information element (IE) configured via RRC, as shown in FIG. 1. A TCI-state IE comprises the following elements:
One of more reference signal(s), and
for each reference signal, one or more quasi-colocation (QCL) assumptions.

The TCI-state is used to mention how to receive a PDSCH or the PDCCH(s) transmitted on a CORESET. Applying a TCI-state to a PDSCH or CORESET implies that the DMRS ports of the PDSCH or the DMRS ports of the PDCCH(s), transmitted on the CORESET, shall be assumed to be quasi-colocated with the reference signals mentioned in the TCI-state according to the corresponding quasi-colocation assumptions for the reference signal mentioned in the TCI-state.

Assuming ‘quasi-colocation’ means that certain channel parameters such as Doppler shift/spread, delay spread, average delay and/or Tx beam direction are assumed to be the same for the DL RS mentioned in the TCI-state and the DMRS ports of the PDSCH, or the DMRS ports of the PDCCH(s) transmitted on the CORESET. Four different QCL types can be indicated in 3GPP Rel. 15 [4].
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

One or more of the QCL-Info parameters is/are included in the TCI-state IE to provide the QCL assumption(s) associated with the TCI-state.

For example, a TCI-state IE comprising a DL reference signal ‘A’ with QCL assumption ‘QCL-typeA’ and a DL reference signal ‘B’ with QCL-assumption ‘QCL-TypeD’ is considered. Applying this TCI-state to a PDSCH or CORESET with the given quasi-colocation assumptions means that the UE shall assume the same Doppler shift, Doppler spread, average delay and delay spread for the DMRS ports of the PDSCH or the DMRS ports of the PDCCH(s) transmitted on the CORESET and the DL reference signal A, and the UE shall use the same spatial filter to receive the DL reference signal ‘B’ and the DMRS ports of the PDSCH or the DMRS ports of the PDCCH(s) transmitted on the CORESET.

Usually, the TCI state that is used to schedule a PDCCH or a PDSCH contains the identifiers (IDs) of channel state information reference signals (CSI-RS) or synchronization signal blocks (SSB) along with the QCL assumptions for each reference signal. The RS in the TCI-state is usually a RS that the UE has measured before, so that it can use it as a reference to receive the DMRS of the PDCCH or PDSCH, and hence demodulate the same. The indication of a TCI-state for a CORESET or a PDSCH is performed via MAC Control Element (MAC-CE) messages or using the TCI-indication field in the downlink control information (DCI) used to schedule the PDSCH.

In FR2, where the gNB and UE establish a connection via spatially selective/directive beams, the TCI-state is used to indicate the beam directions in which the UE must receive, i.e., the spatial filter to be used by the UE to receive a PDSCH/PDCCH(s) via a ‘qcl-TypeD’ assumption with a CSI-RS or an SSB that the UE has already received. The determination of the DL Tx beam to transmit PDCCH(s)/PDSCH is performed via a beam sweeping procedure. In a beam sweeping procedure, the gNB configures a set of DL RSs (CSI-RS or SSB) for the UE to measure in the DL via the RRC. Each of the configured DL RS may be transmitted with a different spatial filter, i.e., each of the configured DL RS may be transmitted in a different direction by the gNB. The UE measures each of the configured DL RS by receiving them using one or more spatial filters—the RSs may all be received with the same spatial filter or a different spatial filter may be used to receive each RS. Following the measurements, the UE sends a beam report to the gNB. The beam report comprises the indices of 1≤L≤4 configured DL RSs (essentially, L DL Tx beam directions, with each beam direction resulting from the use of a specific spatial filter at the gNB) along with the received power in each of the RSs [4]. With the help of the beam report, the gNB determines one or more suitable DL Tx beam direction(s), i.e., spatial filter(s) for the transmission of the PDCCH(s) and the PDSCH.

### 1.2 Physical Uplink Control Channel (Pucch)

The physical uplink control channel carries control information such as channel state information (CSI) feedback, the hybrid automatic repeat request (HARQ) acknowledgement (ACK)/negative acknowledgements (NACK) for physical downlink shared channel (PDSCH) transmissions, and scheduling requests (SR). A unit of the PUCCH that carries uplink control information (UCI) is a PUCCH resource. A PUCCH resource is an RRC configured space in a certain format (format 0, 1, 2, 3) in a certain UL bandwidth-part (BWP) [3, 6] as shown in FIG. 2. The UL-BWP is a contiguous frequency domain space on which the UE transmits in the UL. The UE may be configured with up to 4 UL-BWPs, and it transmits on only one of them at a given time instance. The UL BWP on which the UE transmits is the active UL BWP. The UE is configured with four PUCCH resource sets via RRC. The PUCCH resources in a given PUCCH resource set can carry a specified load of uplink control channel information as indicated by the higher-layer parameter ‘maxPayloadMinus1’ [3]. The other parameters in the PUCCH resource configuration indicate the frequency hopping characteristics of the PUCCH resource.

The PUCCH resources that may carry the various types of the uplink control information (UCI)
Hybrid automatic repeat request (HARQ) acknowledgement (ACK)/negative acknowledgements (NACK) for physical downlink shared channel (PDSCH) transmissions, scheduling requests (SR) and DL channel state information (CSI) feedback—are configured and indicated as follows [2, 3, 6]:
The PUCCH resource that carries the HARQ ACK/NACK for a PDSCH, is indicated by a 3-bit PUCCH resource indicator field in the PDCCH that schedules the PDSCH. The mapping from the PUCCH resource indicator field contained in the PDCCH to a PUCCH resource in the four PUCCH resource sets is configured by the gNB via RRC as described in [3].
The scheduling requests (SR) are configured via RRC in the ‘SchedulingRequestConfig’ IE and other associated IEs, and each scheduling request configuration includes the IDs of PUCCH resource(s) that carry the SRs. The transmission settings of the SRs (periodicity, offset, etc.) are configured at the RRC level.
The CSI report configurations received via RRC at the UE includes the IDs of the PUCCH resources(s) that carry the semi-persistent and/or periodic CSI reports in the UL. The transmission settings of the same are provided in the CSI report configurations. The activation/deactivation of the semi-persistent CSI reports is handled via MAC-CE messages. The configuration of the CSI reports via RRC is enough for the transmission of periodic CSI reports.

The beam direction and power control settings of the PUCCH resources are configured together in a ‘PUCCH-SpatialRelationInfo’ IE, as shown in FIG. 3. The parameter ‘referenceSignal’ in the PUCCH-SpatialRelationInfo IE contains the ID of a DL reference signal (a CSI-RS, or an SSB), or a UL reference signal (sounding reference signal-SRS). The other parameters in the PUCCH-SpatialRelationInfo IE comprise open and closed loop power control settings for the PUCCH transmission. Applying a ‘PUCCH-SpatialRelationInfo’ IE to a PUCCH resource means that the UE shall use the same spatial filter as it uses for the reception of the DL RS or the transmission of the UL RS mentioned in the parameter ‘referenceSignal’ of the IE for the transmission of the PUCCH resource, and should apply the power control parameters in the IE to derive the transmit power for the transmission of the PUCCH resource.

The derivation of the transmit power of a PUCCH resource comprises the addition of open loop and closed loop power adjustments. If a UE transmits a PUCCH on an active UL bandwidth-part (BWP) b and carrier f in the primary cell c using a PUCCH power control adjustment state with index l, the UE determines the PUCCH transmission power P_{PUCCH,b,f,c}(i, qᵤ, q_{d}, l) in PUCCH transmission occasion i as [3],

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + \\ {Δ}_{F \_ PUCCH} ( F ) + {Δ}_{TF , b , f , c} ( i ) + {g}_{b , f , c} ( i , l )\end{matrix}\end{matrix} \} [ dBm ]$$

where,
P_{CMAX, f,c}(i) is the configured maximum UE transmit power defined in [7] and [8],
P_{O_PUCCH,b,f,c}(qᵤ) is the sum of the nominal PUCCH transmit power P_{O_NOMINAL_PUCCH}, provided by a higher layer parameter p0-nominal (or set to a default value of 0 dBm), and P_{O_UE_PUCCH}(qᵤ) provided by the parameter p0-PUCCH-Value and other dependent parameters. The ID of the p0-PUCCH-Value to choose is provided in p0-PUCCH-Id in the PUCCH-SpatialRelationInfo IE (shown in FIG. 3). The value qᵤ is the size of for a set of P_{O_UE_PUCCH} values provided via the higher layer parameter maxNrofPUCCH-P0-PerSet [6].
M_{RB,b,f,c}^{PUCCH}(i) is the bandwidth of the PUCCH resource [1], which is obtained from the configuration of the PUCCH resource.
PL_{b,f,c}(q_{d}) is a downlink pathloss estimate in dB calculated using RS resource index q_{d} as described in [3]. The UE may be indicated explicitly with a pathloss reference RS for PUCCH via a PUCCH-SpatialRelationInfo. The pathloss reference RS is essentially a DL RS from which the UE estimates the pathloss from the gNB or any other network entity.
The parameters Δ_{F_PUCCH}(F) and Δ_{TF,b,f,c}(i) are PUCCH power adjustment factors dependent on the PUCCH format.
The parameter g_{b,f,c}(i, l) is a closed loop power adjustment dependent on a PUCCH power control adjustment state (configured in the parameter closedLoopIndex in the PUCCH-SpatialRelationInfo IE).

The UE is configured up to 8 PUCCH-SpatialRelationInfo parameters in 3GPP Rel. 15.

A specific beam direction and power control setting is applied to a PUCCH resource via a MAC-CE message (as shown in FIG. 4 [5]) in 3GPP Rel. 15 that associates a PUCCH resource with a PUCCH-SpatialRelationInfo. To set the beam direction and power control settings for P PUCCH resources, for example, P MAC-CE messages would therefore be required. The MAC message is used to update he beam direction and power control settings of a PUCCH resource by indicating a PUCCH-SpatialRelationInfo parameter.

### 1.3 Sounding Reference Signal (Srs)

Sounding reference signals (SRS) are used for sounding the UL channel. The basic unit of the SRS is an SRS resource, which is a specific pattern of reference symbols in time, frequency and code transmitted by all or a subset of UE's antenna ports in the UL to sound the UL channel. The UE is configured by the gNB via RRC with one or more SRS resource sets, with each SRS resource set consisting of one or more SRS resources (shown in FIG. 5 and FIG. 6 [6]).

As seen in FIG. 5 and FIG. 6., the power control settings for SRS such as ‘alpha’, ‘p0’ and ‘pathlossReferenceRS’ are configured at SRS resource set level and the beam direction settings are configured at SRS resource level (in the ‘SRS-SpatialRelationInfo’ IE). In 3GPP Rel. 15, both the beam direction and power control settings for SRS can be indicated to the UE only via RRC signaling with the SRS resource or SRS resource set IEs provided above. If the settings need to be changed for an SRS resource, RRC signaling must be performed to reconfigure the SRS resource or the SRS resource set IEs with the new settings.

The transmit power of SRS is thereby obtained by a combination of parameters configured/indicated to the UE as follows: If a UE transmits SRS on active UL BWP b of carrier f of serving cell c using SRS power control adjustment state with index l, the UE determines the SRS transmission power P_{SRS,b,f,c}(i, qₛ, l) in SRS transmission occasion i for the SRS resource set qₛ as

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot \\ {PL}_{b , f , c} ( {q}_{d} ) + {h}_{b , f , c} ( i , l )\end{matrix}\end{matrix} \} [ dBm ]$$

where,
P_{CMAX, f,c}(i) is the configured maximum UE transmit power
P_{O_SRS,b,f,c}(q) is provided by the higher layer parameter p0 or the nominal PUSCH Tx power
M_{SRS,b,f,c}(i) is a SRS bandwidth expressed in number of resource blocks, which is obtained from the SRS configuration
PL_{b,f,c}(qₐ) is a downlink pathloss estimate in dB calculated from the DL RS q_{d} as described in [3] for the SRS resource set qₛ. The pathloss estimate may be derived from the pathlossReferenceRS (a CSI-RS or an SSB resource) configured in the SRS resource set IE.
α_{SRS,b,f,c}(qₛ) is a pathloss compensation factor configured by the higher layer parameter Alpha.
h_{b,f,c}(i, l) is a closed loop power correction function that is dependent on the closed loop power control adjustment state configured in the SRS resource set IE (shown in FIG. 5).

### 1.4 Physical Uplink Shared Channel (Pusch)

PUSCH transmission(s) can be dynamically scheduled via an UL grant in a PHY-layer downlink control information (DCI) or semi-persistently/statically scheduled with the higher layer configured grant configuredGrantConfig. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI [3] after the reception of higher layer parameter configurdGrantConfig not including rrc-ConfiguredUplinkGrant [4].

The physical uplink shared channel can be transmitted in 3 modes: codebook, non-codebook and single-port. The codebook- and non-codebook-based PUSCH transmissions are scheduled using downlink control information (DCI) format 0_1 [4] if the DCI is used in the dynamic or semi-persistent scheduling of the PUSCH. When the PUSCH is scheduled with DCI format 0_0, the UE uses a single port for the PUSCH transmission [4]. The beam direction and power control settings for the PUSCH are differently configured/indicated from that of the PUCCH.

The beam direction of the PUSCH is determined from the beam direction of an SRS or a PUCCH resource depending on the mode of PUSCH transmission:
Codebook- or non-codebook-based PUSCH transmission is indicated with an SRS resource in 3GPP Rel. 15. The UE sounds the UL channel with SRS resources (which are configured specifically for the codebook/non-codebook transmission mode) and the gNB, in return, schedules the PUSCH via the indication of an SRS resource. The UE, thereby, transmits the PUSCH from the same ports from which the SRS resource was transmitted and uses the same spatial filter for the transmission of the PUSCH as for the transmission of the SRS resource.
When the UE is scheduled by DCI format 0_0 (single-port PUSCH), the spatial filter used for the transmission of the PUSCH is the same as that used for the transmission of the PUCCH resource with the lowest ID in the currently active UL bandwidth part (BWP).

The power control settings for PUSCH are obtained as follows for the different modes of transmission:
The power control settings for codebook- or non-codebook-based PUSCH transmission is configured in ‘SRI-PUSCH-PowerControl’ IEs. These IEs contain the ID of a pathloss reference RS, ‘alpha’ values (pathloss compensation factor) and the closed loop power control index. The SRS resource indicator mentioned for the codebook/non-codebook PUSCH transmission (in DCI format 0_1 or in a higher layer configuration of the PUSCH transmission) maps to a ‘SRI-PUSCH-PowerControl’ IE that provides these power control settings.
For single-port PUSCH (scheduled by DCI format 0_0), the pathloss reference RS is borrowed from a PUCCH resource. The rest of the power control parameters are obtained from PUSCH settings described in [3].

The transmit power of PUSCH is thereby determined from a combination of open loop and closed loop power control parameters. If a UE transmits a PUSCH on active UL BWP b of carrier f of serving cell c using parameter set configuration with index j and PUSCH power control adjustment state with index l, the UE determines the PUSCH transmission power in PUSCH transmission occasion i as

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{TF , b , f , c} ( i ) + {f}_{b , f , c} ( i , l )\end{matrix}\end{matrix} \} [ dBm ]$$

where,
P_{CMAX, f,c}(i) is the configured maximum UE transmit power defined in [7] and [8]
P_{O_PUSCH,b,f,c}(j) is a parameter composed of the sum of the nominal PUSCH transmission power P_{O_NOMINAL_PUSCH,f,c}(j) and P_{O_UE_PUSCH,b,f,c}(j) both of which are configured via a higher layer by the gNB [3].
M_{RB,b,f,c}^{PUSCH}(i) is the bandwidth of the PUSCH resource assignment expressed in number of resource blocks
PL_{b,f,c}(q_{d}) is a downlink pathloss estimate in dB calculated by the UE using DL reference signal (RS) index q_{d}. The configuration/indication of the pathloss reference RS is as described above.
α_{b,f,c}(j) is a pathloss compensation factor configured via a higher layer by the gNB.
f_{b,f,c}(i, l) is a closed loop power correction function that changes depending on the transmit power control (TPC) feedback from the gNB.
Δ_{TF,b,f,c}(i) is a power offset value dependent on the MCS used for the PUSCH.

From the above discussion on the UL beam direction and power control framework in 3GPP Rel. 15, issues related to RRC overhead and redundancy have been identified. This overhead in turn leads to higher latency in the update of UL transmission settings which might prove to be a bottleneck when the UE is mobile, for example in FR2 operation.

Some of the specific issues identified in the UL beam direction configuration and indication framework are as follows:
1. Separate beam direction configuration for PUCCH and SRS: The indication of the beam directions for UL channels and UL RSs are handled in different ways. For example, the beam direction settings for PUCCH resources are configured in ‘PUCCH-SpatialRelationInfo’ IEs (up to 8 can be configured in 3GPP Rel. 15) and then individually applied to PUCCH resources at the UE via MAC-CE commands signaled by the gNB. A MAC-CE command associates a configured ‘PUCCH-SpatialRelationInfo’ parameter with a PUCCH resource. Similarly, in the case of SRS, the beam direction for each SRS resource is configured via the RRC layer using ‘SRS-SpatialRelationInfo’ IEs. Configuring beam directions separately for SRS and PUCCH may lead to the configuration of the same beam direction, i.e., configuration of a ‘PUCCH-SpatialRelationInfo’ IE and an ‘SRS-SpatialRelationInfo’ IE with the same RS in the ‘referenceSignal’ parameter of the associated IEs. This redundancy in the configured beam directions is unnecessary and may be avoided.
2. Redundancy in beam direction configuration for UL and DL and inflexibility to exploit beam correspondence: Beam correspondence is a UE feature reported to the gNB by the UE in 3GPP Rel. 15. A simple explanation for the term ‘beam correspondence’ is that the beam formed in a direction by the UE when it receives is roughly the same as the beam it forms in same direction when it transmits in terms of the effective isotropic radiated power (EIRP) [7, 8]. For UEs satisfying beam correspondence, the indication of beam directions and power control settings can be handled differently in a way that reduces control information overhead. In 3GPP Rel. 15, the beam directions for the transmission of a PUCCH or SRS is indicated explicitly by the gNB for a particular PUCCH or SRS resource, and the UE is instructed to use the same spatial filter that is used for the reception of a DL RS or the transmission of an UL RS. However, such explicit indication might not be required for UEs satisfying beam correspondence. When the UE satisfies beam correspondence, it would suffice to associate a PUCCH or SRS resource to a DL channel (PDSCH/PDCCH), thereby allowing for the UL beam for the PUCCH or the SRS to be automatically changed in the direction of a DL channel whenever the beam direction to receive the DL channel is modified via TCI-state indication for the DL channel. The 3GPP Rel. 15 specifications support only the explicit indication of beam directions with UL and DL RSs and do not specify methods that can exploit beam correspondence and avoid such explicit beam direction indication and thereby reduce control overhead. An example message flow chart of the signaling required in 3GPP Rel. 15 to indicate or change a UE UL beam is provided in FIG. 7. The message flow chart shows the process involved in indicating a beam for a UE satisfying beam correspondence. Even when the gNB wants the UE to follow the DL beam direction for the UL, explicit signaling of the beam direction for both the DL and the UL must be performed to the UE by the gNB. The UE in the illustration satisfies beam correspondence and the gNB wants the UL beam direction of the UE to follow the DL beam direction

The UL beam direction configuration and indication framework in 3GPP Rel. 15 is illustrated in FIG. 8. The beam directions for SRS are configured at the RRC level for each SRS resource. The lower layer does not play any role in indicating the beam directions for SRS. Any changes in the beam direction for SRS is indicated to the UE via RRC reconfiguration of the SRS resource. In the case of PUCCH, multiple beam directions and power control settings are configured in multiple PUCCH-SpatialRelationInfo configurations. The ‘PUCCH-SpatialRelationInfo’ configurations are configured generally for all PUCCH resources and are not specific to any PUCCH resource. A PUCCH resource is applied with a specific PUCCH-SpatialRelationInfo setting (a beam direction and power control setting) via a MAC-CE message. In such a framework, if a PUCCH resource and SRS resource should be beamformed in the same direction, separate configuration of the beamforming directions must be performed at the RRC level. Moreover, any changes to the beam direction of an SRS resource are performed only via RRC reconfiguration which leads to a beam switch latency.

The UL beam direction configuration and indication framework in 3GPP Rel. 15 is illustrated in FIG. 8. The beam directions for SRS are configured at the RRC level for each SRS resource. The lower layer does not play any role in indicating the beam directions for SRS. Any changes in the beam direction for SRS is indicated to the UE via RRC reconfiguration of the SRS resource. In the case of PUCCH, multiple beam directions and power control settings are configured in multiple PUCCH-SpatialRelationInfo configurations. The ‘PUCCH-SpatialRelationInfo’ configurations are configured generally for all PUCCH resources and are not specific to any PUCCH resource. A PUCCH resource is applied with a specific PUCCH-SpatialRelationInfo setting (a beam direction and power control setting) via a MAC-CE message. In such a framework, if a PUCCH resource and SRS resource should be beamformed in the same direction, separate configuration of the beamforming directions must be performed at the RRC level. Moreover, any changes to the beam direction of an SRS resource are performed only via RRC reconfiguration which leads to a beam switch latency.

In addition to the issues in UL beam management discussed above, the inflexibility of the configuration and indication of UL power control settings in 3GPP Rel. 15 is also noteworthy. The pathloss reference RSs used in the derivation of the pathloss factor in the UL Tx power expressions change with respect to UE mobility. In FR2, when the UE moves within the cell, the pathloss reference RS changes with the DL beam used for PDSCH/PDCCH transmissions. Therefore, the list of the pathloss reference RSs configured for the UE and the IEs used to indicate power control settings that refer to the pathloss reference RS IEs have to be constantly reconfigured to keep up with UE mobility, which leads to a lot of control information overhead and latency. However, the power control settings other than the pathloss reference RSs may not change with UE mobility and may be retained by the UE. Therefore, the power settings configuration must be flexible enough to modify only the necessary settings and avoid unnecessary reconfiguration of settings that may stay constant when the UE is mobile. It is therefore necessary to decouple the pathloss reference RSs from the rest of the power control settings and enable implicit updates of the same from the beam(s) of DL channels.

### SUMMARY

In view of the above drawbacks, it is an objective of the embodiments herein to provide an overhaul of the UL beam configuration and indication framework and the UL power settings framework to reduce control information overhead and latency of UL beam and power settings indication at the UE. It also provides methods to the exploit of the UE's beam correspondence capability to reduce redundant higher layer configurations and use implicit methods for the derivation of UL spatial filter and pathloss reference RSs. The proposed overhaul of the beam management framework may be used along with or separate from the implicit beam direction and pathloss reference RS derivation methods according to some exemplary embodiments of the present invention

According to an aspect of embodiments herein, there is provided a method performed by a UE, the method comprising: receiving, from a network node, via a higher layer, a configuration of an Information element, IE, comprising a set of parameters used for the configuration of an uplink, UL, beam direction or a spatial filter to be used in a UL transmission; wherein the IE contains at least: an ID, unique to each IE and an ID of an UL reference signal, RS resource or a downlink, DL, RS resource; and applying the UL beam direction or spatial filter IE for the transmission of one or more of the Physical Uplink Shared Channel, PUSCH, Physical control channel, PUCCH resource(s) and/or Sounding Reference Signal, SRS resource(s)

According to an aspect of embodiments herein, there is provided a method performed by the UE comprising: receiving, from a network node, a higher layer configuration of at least one downlink reference signal, RS, as a pathloss reference in an, Information Element, IE, containing at least the following parameters: an ID unique for the pathloss reference RS and the ID of a DownLink, DL, Reference Signal, RS; and using said pathloss reference RSs in the configuration of the power control setting(s) and/or in the indication of the pathloss reference for PUCCH resource(s) and either SRS resource(s) or PUSCH or both.

According to another aspect, there is provided a method performed by a UE comprising receiving, from a network node, a higher layer configuration of a grouping/association of Physical Uplink Control Channel, PUCCH, resources:

using CORESET ID values or CORESET group ID values, or by using a PUCCH resource group identifier, PUCCH resource group ID, that is derived from the transmit/receive point (TRP) the PUCCH resources are associated with.

According to another aspect there is provided a method performed by a UE comprising-receiving, from a network node, an Information Element, IE, via a higher layer, of one or more power control settings for a PUCCH, PUCCH-PC-setting, wherein a power control setting contains at least the following parameters: an ID unique for each power control setting IE, a closed loop power control index, a p0-PUCCH-ID and optionally the ID of a pathloss reference RS for PUCCH.

According to another aspect there is provided a UE comprising a processor and a memory, said memory containing instructions executable by said processor whereby the UE is operative to perform any one of the subject-matter of method claims 1-53.

There is also provided a computer program comprising instructions which when executed on at least one processor of the UE claim 54, cause the at least said one processor to carry out the method according to anyone claims 1-53.

A carrier is also provided containing the computer program, wherein the carrier is one of a computer readable storage medium; an electronic signal, optical signal or a radio signal.

Additional embodiments according to other aspects of the present invention are presented in the detailed description.

### BRIEF DESCRIPTION OF THE DRAWINGS

FIG. 1 depicts RRC configuration of the TCI-state Information Element (state of the art)

FIG. 2 depicts RRC Information Elements used to configure PUCCH resources and PUCCH resource sets (state of the art)

FIG. 3 depicts configuration of PUCCH-SpatialRelationInfo (state of the art)

FIG. 4 depicts MAC-CE message to update beam direction and power control settings of a PUCCH resource (state of the art)

FIG. 5 illustrates SRS resource set configuration (state of the art)

FIG. 6 shows SRS resource configuration (state of the art)

FIG. 7 depicts a message flowchart showing the process of beam indication in 3GPP rel. 15 (state of the art)

FIG. 8 illustrates the configuration of the beam directions for PUCCH and SRS resources and the power settings for a PUCCH resource (state of the art)

FIG. 9 illustrates a direction beam configuration and indication framework to address beam switch latency and control information redundancy and overhead according to some embodiments herein

FIG. 10 illustrates an example of configuration of UL-SpatialFilter IE

FIG. 11 illustrates examples of MAC-CE messages used to indicate a PUCCH/SRS resource with a UL-SpatialFilter IE

FIG. 12 illustrates an example configuration of the UL-SpatialFilter IE comprising a CORESET ID

FIG. 13 illustrates message flow chart showing the process of beam indication in the proposed framework using a CORESET as a beam reference.

FIG. 14 illustrates an example configuration of a PUCCH resource IE with a CORESET group ID to group PUCCH resources

FIG. 15 illustrates an example configuration of the pathloss reference RS IE

FIG. 16 is an illustration of pathloss RS configuration and pathloss factor computation in 3GPP Rel. 15 (state of the art)

FIG. 17 illustrates pathloss RS configuration and pathloss factor computation according to an embodiment

FIG. 18 illustrates an example configuration of a pathloss reference RS containing a CORESET ID

FIG. 19 illustrates an example of higher layer configuration of PUCCH-PC-setting IE.

FIG. 20 illustrates a flowchart of a method performed by a UE according to some embodiments

FIG. 21 illustrates a block diagram depicting a UE according to some embodiments herein.

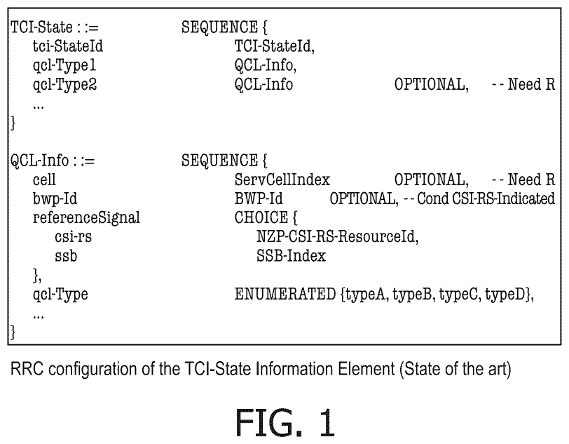

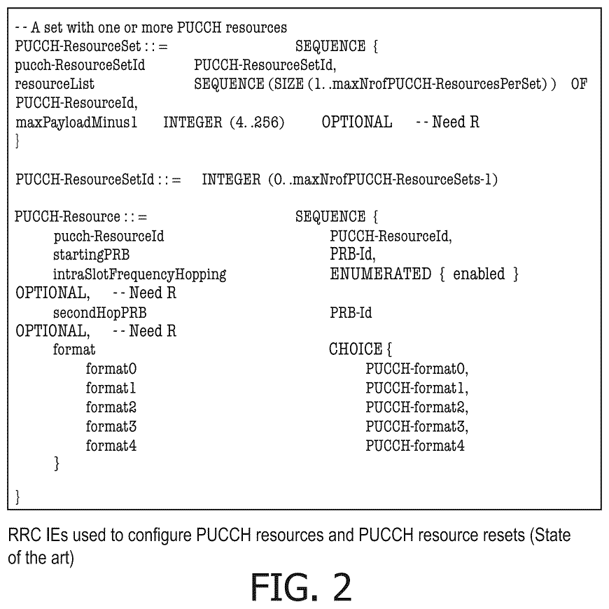

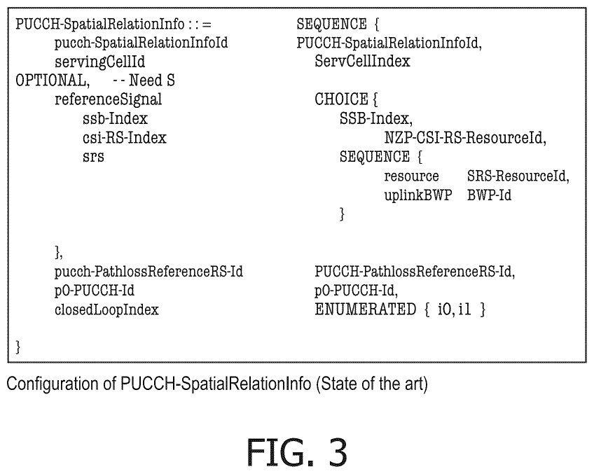

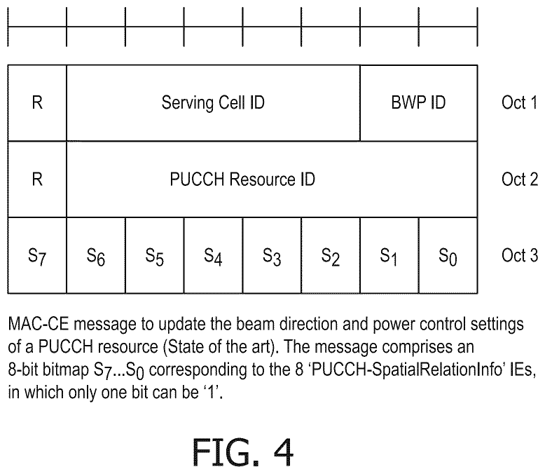

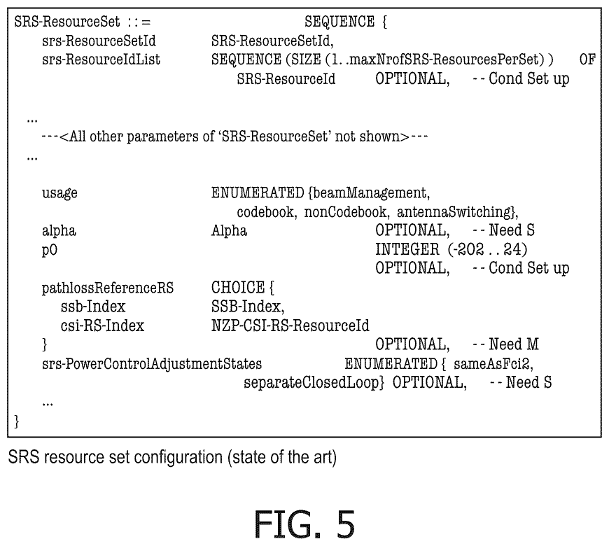

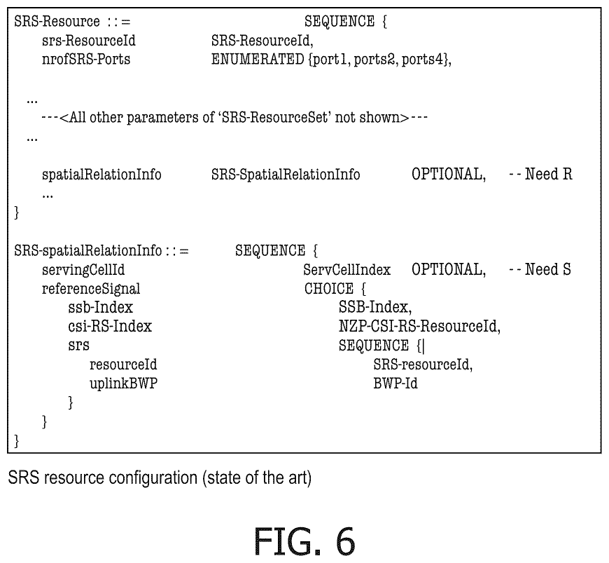

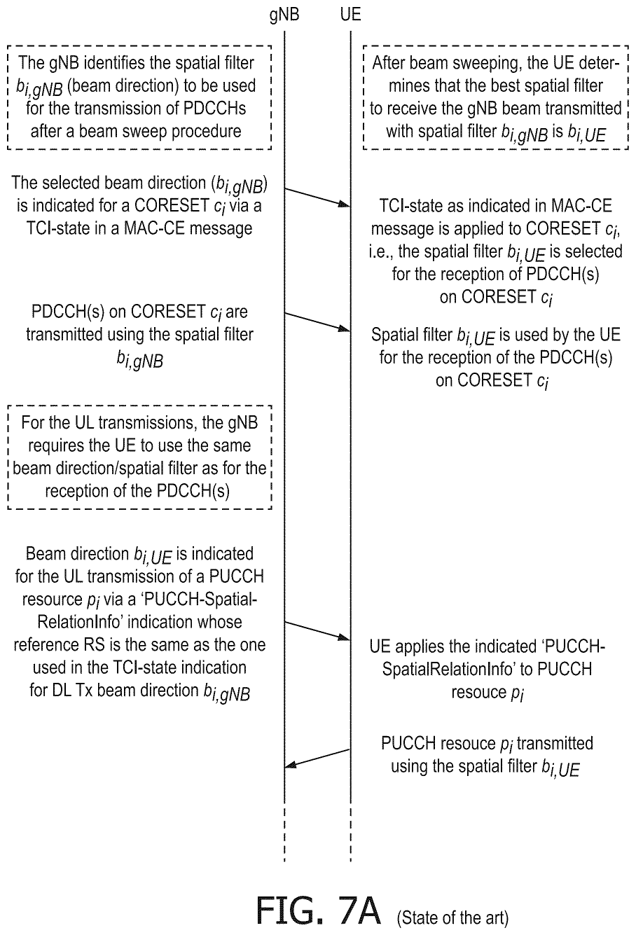

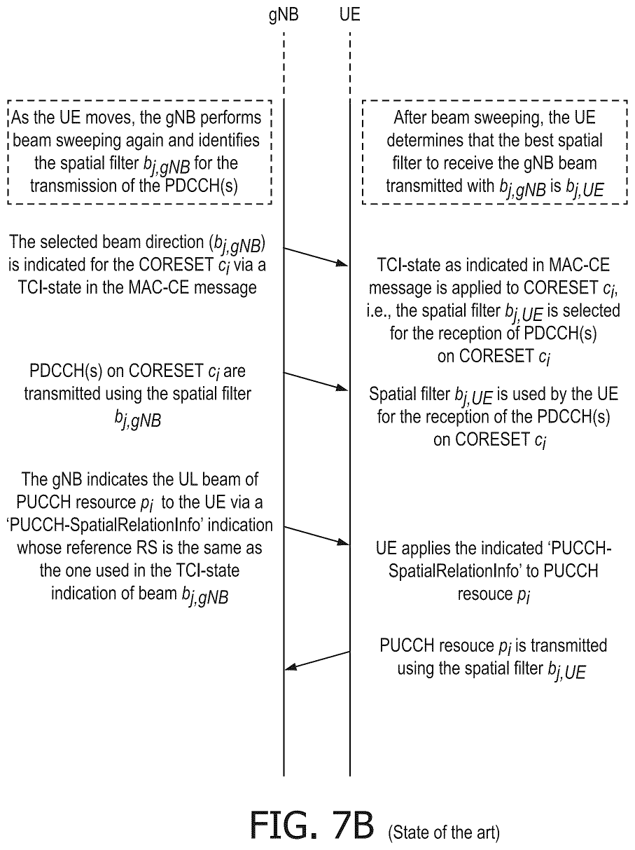

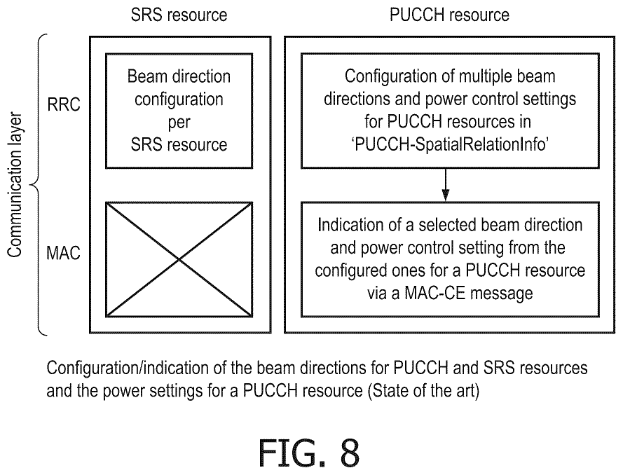

### DETAILED DESCRIPTION

In the following, a detailed description of the exemplary embodiments is described in conjunction with the drawings, in several scenarios to enable easier understanding of the solution(s) described herein.

In the present embodiments, and as previously described, an overhaul of the UL beam management and power control framework is provided to address the above issues. Methods to configure a common set of beam directions for UL channels and/or RSs, separate from the power control settings are proposed. This is followed by the introduction of methods to implicitly derive beam directions from DL channels/RSs. Methods for the configuration and indication of pathloss reference RSs are further discussed and presented. Implicit methods to derive pathloss reference RS from DL channels are also introduced. The present embodiments further disclose methods to configure PUCCH power control settings and the ways to indicate them.

It is noted that several embodiments are described in the following may be implemented individually or in combination. In other words, some or all of the described embodiments may be combined-unless mutually exclusive.

### 2.1 Configuration and Indication of Beam Directions for UL Channels and Reference Signals

The configuration and indication framework of the beam directions for PUCCH resources and SRS resources in 3GPP Rel. 15 leads to some redundancies as the same beam direction may be configured more than once for various SRS and PUCCH resources. The combined configuration of power control and beam directions for PUCCH resources makes them usable exclusively for PUCCH resources, and hence when beam directions are configured for SRS resources, the gNB may end up configuring beam directions that have been already configured for PUCCH resources. Moreover, combining the configuration of power control and beam direction is inefficient in addressing the different needs of beam direction indication for UEs with and without beam correspondence capability. Such higher layer configuration leads to large RRC overhead and latency.

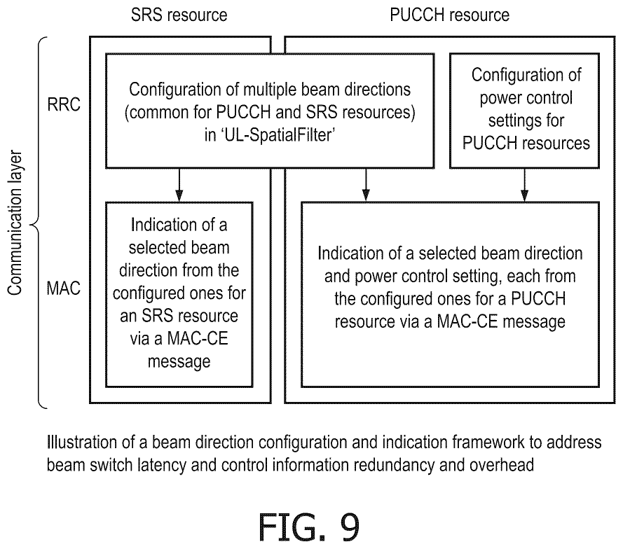

An illustration of a framework that can address the RRC redundancy/overhead in beam direction indication is shown in FIG. 9. Configuring a common set of beam directions for SRS and PUCCH ensures that there is no redundancy in beam direction configuration (configuration of the same beam direction twice, once for PUCCH and once for SRS). In addition, using MAC-CE messages for beam direction indication and update for SRS instead of RRC configuration reduces the latency of a beam switch. In the following, details of the proposed beam configuration and signaling framework are provided.

According to an embodiment there is provided a method performed by a UE comprises: receiving from a, from a network node, via a higher layer, a configuration of an Information element (IE), comprising a set of parameters used for the configuration of an UL beam direction or a spatial filter to be used in a UL transmission; wherein the IE contains at least: an identifier, ID, unique to each IE and an ID of an UL RS resource or a DL, RS resource; and applying the UL beam direction or spatial filter IE for the transmission of one or more of the Physical Uplink Shared Channel, PUSCH, Physical control channel, PUCCH resource(s) and/or Sounding Reference Signal, SRS resource(s).

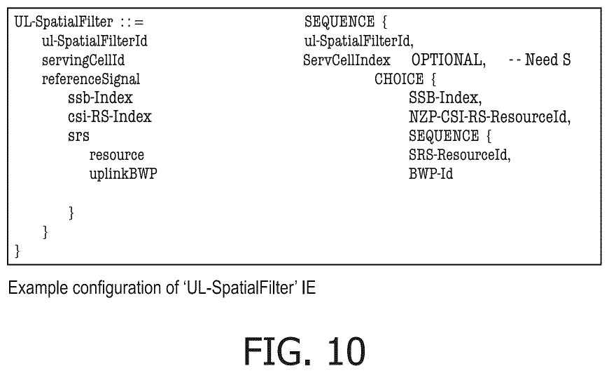

In detail, the UE may be configured to receive from the gNB or any other network entity, the IE via a higher layer (e.g., RRC) comprising a set of parameters used for the configuration of an UL beam direction. For example, the IE may be titled as ‘UL-SpatialFilter’. The ‘UL-SpatialFilter’ IE contains at least the following parameters: an identifier (ID) unique to each ‘UL-SpatialFilter’ IE and an identifier (ID) of an UL or a DL resource. The ID of the UL or DL resource is used to indicate an UL beam direction (spatial filter) for one or more PUCCH resources(s) and/or PUSCH and/or one or more SRS resource(s) in an UL transmission. The ID of the DL or UL resource comprises at least one of the following: a CSI-RS resource, an SRS resource or a synchronization signal block (SSB). An example configuration of the ‘UL-SpatialFilter’ IE is shown in FIG. 10.

In the case that the resource used to indicate the beam direction in the ‘UL-SpatialFilter’ IE is an SRS resource (an UL resource), the ID of the SRS resource and the ID of the uplink bandwidth part (BWP)—the part of UL frequency band-on which the SRS is transmitted may additionally be included. Note that there are multiple UL BWPs configured, but only one active UL BWP is used for the UL transmission. The UL BWP ID is included in the IE for the case that the SRS resource was transmitted in a previously active UL BWP. The spatial filter used to transmit the SRS resource in the UL BWP indicated in the ‘UL-SpatialFilter’ IE is then used for one or more SRS or PUCCH resource(s) in an UL transmission. The serving cell ID contained in the ‘UL-SpatialFilter’ IE indicates the associated cell.

The UE may be configured with B≥1 ‘UL-SpatialFilter’ IEs and the network node or base station or any other network entity may indicate a specific ‘UL-SpatialFilter’ IE (i.e., UL beam direction) for one or more SRS and/or PUCCH resources via a MAC-CE message.

In accordance with an embodiment, the UE is configured to receive from the gNB or any other network entity, a MAC-CE message that contains at least an ID of one or more PUCCH resource(s) or SRS resource(s) and the ID of a ‘UL-SpatialFilter’ IE. The UE may apply the spatial filter IE for the transmission of the UL RS resource, or the reception of the DL RS resource configured in the indicated UL beam direction or spatial filter IE for the transmission of indicated PUCCH resource(s) or SRS (resource(s)).

When the UE is configured with B≥1 ‘UL-SpatialFilter’ IEs, the ID of the ‘UL-SpatialFilter’ IE used in the MAC-CE message may be indicated via a bitmap of length B. Each bit in the bitmap is associated with one of the configured ‘UL-SpatialFilter’ IEs. The bitmap then contains a single ‘1’ indicating the ‘UL-SpatialFilter’ IE to be applied.

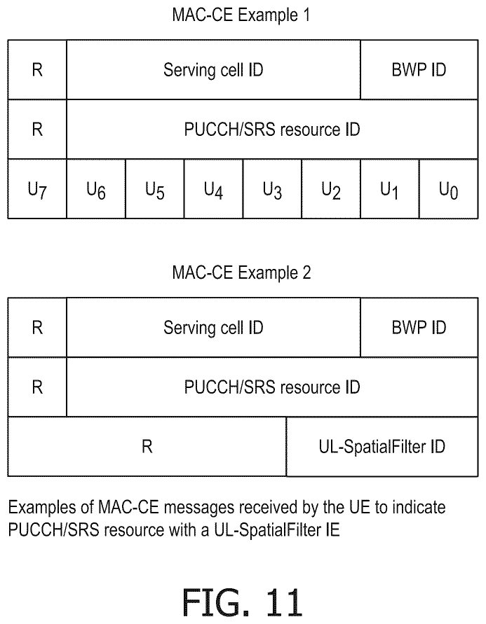

When the UE receives the MAC-CE message, the UE applies the indicated ‘UL-SpatialFilter’ IE to the indicated PUCCH resource(s) or SRS resource(s) (examples of the MAC-CE are shown in FIG. 11). The UE behavior when the ‘UL-SpatialFilter’ is applied to a PUCCH/SRS resource is described below.

Similarly, the beam direction for a PUSCH can be indicated to the UE via the PDCCH that schedules the PUSCH or a higher layer configured UL grant for the PUSCH.

In accordance with an embodiment, the UE is configured to receive from the gNB or any other network entity, an x-bit field in the PDCCH that schedules a PUSCH, wherein the x-bit field indicates a ‘UL-SpatialFilter’ IE. The field may be named, UL-SpatialFilter indicator, for example. When the UE receives the said PDCCH, the UE applies the ‘UL-SpatialFilter’ IE indicated by the UL-SpatialFilter indicator field in the PDCCH to the PUSCH scheduled by the PDCCH.

In accordance with embodiments, the UE is configured to receive from the gNB or any other network entity, a higher layer configuration of an UL grant that comprises the ID of a ‘UL-SpatialFilter’ IE. When the UE receives the higher layer configuration, the UE applies the ‘UL-SpatialFilter’ IE to the PUSCH scheduled by the UL grant.

The application of a UL-SpatialFilter to a PUCCH resource or an SRS resource or a PUSCH results in the following UE behaviour:
If a PUCCH resource or SRS resource or PUSCH ‘U’ is applied with a ‘UL-SpatialFilter’ IE that contains an non-zero-power (NZP) CSI-RS-Resource-Id ‘D’, the UE transmits the PUCCH resource or SRS resource or PUSCH ‘U’ with the same spatial filter used to receive the non-zero-power CSI-RS (NZP-CSI-RS) resource ‘D’.
If a PUCCH resource or SRS resource or PUSCH ‘U’ is applied with a ‘UL-SpatialFilter’ IE that contains an SSB-Index ‘D’, the UE transmits the SRS resource or PUCCH resource ‘U’ with the same spatial filter used to receive the SSB resource ‘D’.
If a PUCCH resource or SRS resource or PUSCH ‘U’ is applied with a ‘UL-SpatialFilter’ IE that contains the ID of an SRS resource ‘U1’, the UE transmits the SRS resource or PUCCH resource ‘U’ with the same spatial filter used to transmit the SRS resource ‘U1’.

In FIG. 11, examples of MAC-CE messages to update a PUCCH/SRS resource with a specific ‘UL-SpatialFilter’ are shown. The example MAC-CE messages shown are both of size 3 octets each and contain a serving cell ID and an UL BWP ID to indicate the cell and the BWP for which the MAC-CE message is intended for. The letter ‘R’ stands for reserved bit(s) that are assigned with ‘0’s.

The example MAC-CE messages shown in FIG. 11 are both of size 3 octets each and contain a serving cell ID and an UL BWP ID to indicate the cell and the BWP for which the MAC-CE message is intended for. The letter ‘R’ stands for reserved bit(s) that are assigned with ‘0’s.

Example 1 shows a MAC-CE message that contains a bitmap to indicate the UL-SpatialFilter IE. Example 2 shows a MAC-CE message that contains the ID of the UL-SpatialFilter IE to be applied

### Extension of ‘UL-SpatialFilter’ IE for UEs Supporting Beam Correspondence

The ‘UL-SpatialFilter’ IE is used to explicitly indicate the beam direction for PUCCH resources, SRS resources and/or PUSCH, especially in FR2. However, such an explicit indication may not be required for UEs supporting beam correspondence. When a UE supports beam correspondence, the UL beam may be derived implicitly from DL channels thereby eliminating the need for explicit indication of the UL beam direction using a DL RS whenever there is a change in the UL beam direction. The implicit UL beam indication is especially helpful when the UE moves within a cell resulting in frequent beam direction changes. The following embodiments provide a method to implicitly derive the UL beam direction from a CORESET so that frequent explicit beam direction indications may be avoided.

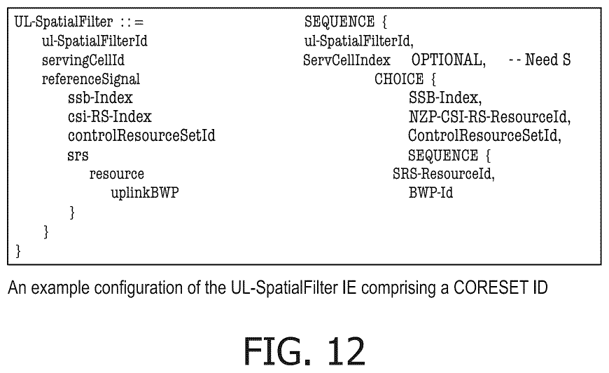

In accordance with embodiments, the UE is configured to receive from the gNB or any other network entity a ‘UL-SpatialFilter’ IE via a higher layer, wherein the ‘UL-SpatialFilter’ IE comprises a CORESET ID. The CORESET ID in the UL-SpatialFilter IE indicates that the UE may use the same spatial filter for the reception of the PDCCH(s), transmitted on the said CORESET, and the transmission of one or more PUCCH resource(s) and/or SRS resource(s) and/or PUSCH in an UL transmission. An example configuration of a ‘UL-SpatialFilter’ IE with a CORESET ID (denoted as ‘controlResourceSetld’) is shown in FIG. 12.

When the UE receives a MAC-CE message indicating an UL-SpatialFilter IE containing a CORESET ID and the ID(s) of one or more PUCCH/SRS resource(s), the UE applies the indicated ‘UL-SpatialFilter’ IE to the indicated PUCCH/SRS resource(s).

Similarly, when the UE receives a PDCCH scheduling a PUSCH with a field indicating a ‘UL-SpatialFilter’ IE containing a CORESET ID or a higher layer configured UL grant scheduling a PUSCH comprising the ID of a ‘UL-SpatialFilter’ IE containing a CORESET ID, the UE applies the indicated ‘UL-SpatialFilter’ IE to the PUSCH scheduled by the PDCCH or the higher layer configured UL grant respectively.

The application of a UL-SpatialFilter containing a CORESET ID to a PUCCH resource or an SRS resource or a PUSCH results in the following UE behaviour:
If a PUCCH resource or an SRS resource or a PUSCH ‘U’ is applied with an ‘UL-SpatialFilter’ IE that contains a CORESET ID ‘D’, the UE transmits the PUCCH resource or SRS resource or PUSCH ‘U’ with the most recent spatial filter used for the reception of the PDCCH(s) transmitted on CORESET ‘D’.

This means, at every instance the spatial filter used for the reception of the PDCCH(s) in a CORESET is changed due to a TCI-state update for the CORESET, the UE also updates the spatial filter used for the transmission of the SRS and/or PUCCH resource(s) to the same spatial filter used for the reception of the PDCCH(s) transmitted on the CORESET. In UE mobility scenarios, this leads to a high reduction in control information signaling.

This method of beam indication may be especially helpful in the case of PUCCH resource(s) carrying ACK/NACKs of PDSCH transmission(s). The UL beam direction of the PUCCH resources may follow the DL beam direction used for the CORESET on which the PDCCH(s) indicating the PUCCH resource(s) are transmitted. Hence, whenever there is a change of the DL beam direction for the PDCCH(s) transmitted on the CORESET, the UL beam direction of the PUCCH resource(s) may change accordingly. In a multi-TRP (transmit/receive point) transmission scenario, where each CORESET may be associated with a particular TRP, this method of beam indication helps to direct the HARQ ACK(s)/NACK(s) for the PDSCH transmitted from a TRP to the same TRP with much less control overhead and latency, even when a UE is mobile and moving within the cell.

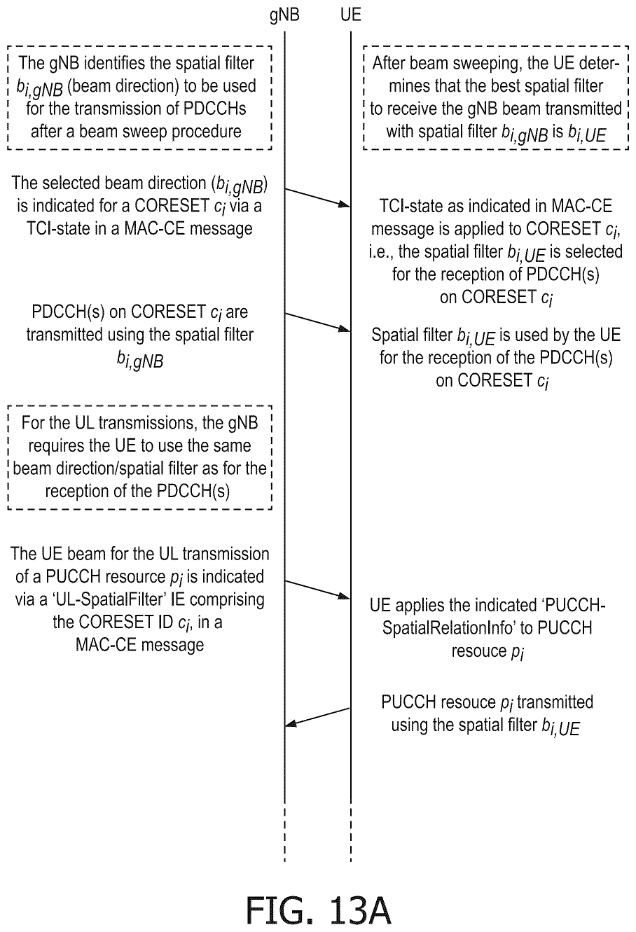

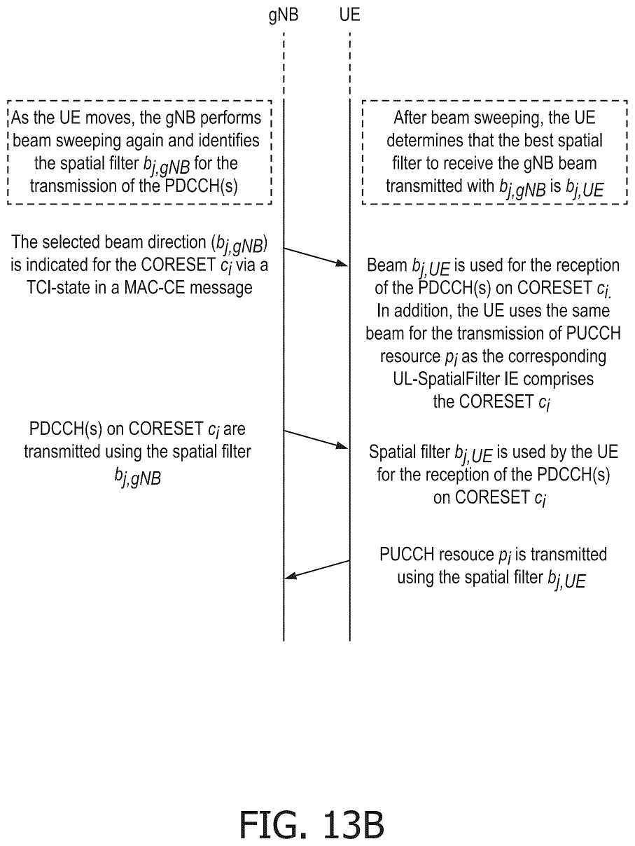

A message flow chart showing the timeline of a beam indication with the help of a CORESET ID is provided in FIG. 13. The message-flow chart shows the process involved in indicating a beam for a UE satisfying beam correspondence. The CORESET is used as a beam reference. When the gNB wants the UE to follow the DL beam direction for the UL beam direction, by using a CORESET ID for spatial filter reference in the UL. Therefore, in each instance of beam change, explicit signaling is avoided and the UL beam direction keeps up with the changes in the DL beam.

### Extension of MAC-CE Message Content for a Group of PUCCH Resources

MAC-CE messages may be used to indicate the UL beam direction for either a single PUCCH resource, or multiple, i.e., a group of PUCCH resources. The MAC-CE indication for a group of PUCCH resources may enable the gNB to update properties for groups of PUCCH resources, thereby reducing the signaling overhead. Such properties may include an UL beam direction, a power control setting, or a HARQ codebook. The indication of these properties for a group of PUCCH resources may be aided using a higher layer configured grouping method. In the following, various grouping schemes for PUCCH resources are discussed and associated MAC-CE message indications are introduced.

In accordance with an embodiment, the UE is configured to receive from the gNB or any other network entity, a higher layer configuration of a grouping/association of PUCCH resources using CORESET ID values or CORESET group ID values. The CORESETs configured for a UE may be grouped via higher layer configuration, for example, according to the transmit/receive point (TRP) they are associated with. In a multi-TRP transmission scenario, a CORESET is associated with a TRP. The set of CORESETs that are associated with a TRP may be grouped with a common CORESET group ID via higher layer configuration. The PUCCH resources associated with a specific CORESET ID/CORESET group ID value via higher layer configuration form a PUCCH resource group. When grouped in connection with a CORESET or a CORESET group in the DL, the properties of the PUCCH resources such as beam direction, power control settings and HARQ codebook can be modified in connection with the CORESET or the CORESET group they are associated with, especially for UEs with beam correspondence.

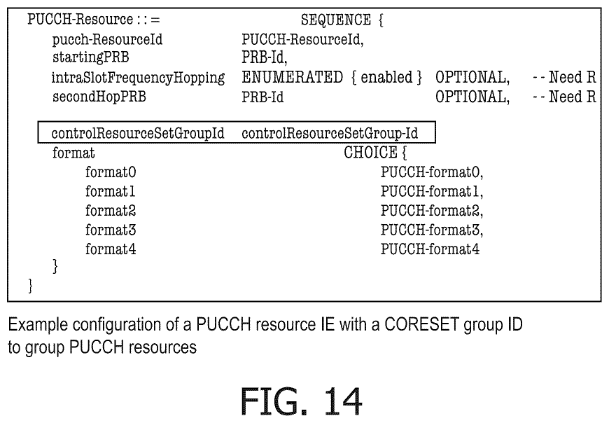

An example of associating a PUCCH resource IE with a CORESET via PUCCH resource IE configuration is provided in FIG. 14. The example shows the configuration of a PUCCH resource IE with a CORESET group ID to group PUCCH resources. The PUCCH resources may also be grouped with respect to a CORESET ID or a PUCCH resource group ID as described. In other PUCCH resource grouping methods, the ID used to group them may be decoupled from DL channels or resources or RSs.

In accordance with an embodiment, the UE is configured to receive, from the gNB or any other network entity, a higher layer configuration of a grouping/association of PUCCH resources using an ID that may be derived from the transmit/receive point (TRP) the PUCCH resources are associated with. The ID may be called ‘PUCCH Resource Group ID’, for example. The grouping with respect to TRPs may be performed in multi-TRP scenarios when the uplink control information (UCI) specific to a TRP such as CSI feedback and HARQ ACK(s)/NACK(s) for PDSCHs transmitted from a TRP, may be transmitted to the same TRP. With this method of grouping, the properties of PUCCH resources may be modified independent of the DL resources/channels such as CORESETs or PDSCHs. It may be especially helpful in the following scenarios:
UEs without beam correspondence: the UL beam direction for such UEs may not be derived from CORESETs or PDSCHs and it has to be set independent of the DL resources.
Asymmetric multi-TRP communication: in multi-TRP scenarios when the DL transmissions may be configured for the UE from m TRPs and the UL transmissions are to be performed to n≠m TRPs, the grouping of the PUCCH resources for joint update of their properties must be decoupled from the DL resources to accommodate for the asymmetry between the DL and the UL transmissions.

Considering the PUCCH resource grouping techniques described above, MAC-CE messages can be used to indicate the beam direction for a group of PUCCH resources.

In accordance with an embodiment, the UE is configured to receive from the gNB, a MAC-CE message that contains at least the following: a serving cell ID, a CORESET ID or a CORESET group ID, an ‘UL-SpatialFilter’ ID and optionally, an UL BWP ID. When the UE receives the MAC-CE message without the UL BWP ID, the UE applies the UL-SpatialFilter to the PUCCH resources configured with the indicated CORESET ID or CORESET group ID or to any PUCCH resource(s) indicated via the PUCCH resource indicator field by the PDCCH(s) transmitted on the indicated CORESET or on the CORESET(s) belonging to the indicated CORESET group. The serving cell ID indicates the cell the MAC-CE message is intended for. If the MAC-CE is received with an UL BWP ID, the UL-SpatialFilter is applied to the said PUCCH resources configured only within the indicated UL BWP.

In accordance with an embodiment, the UE is configured to receive from the gNB, a MAC-CE message that contains at least the following: a serving cell ID, a PUCCH resource group ID, an ‘UL-SpatialFilter’ ID and optionally, an UL BWP ID. When the UE receives the MAC-CE, the UE applies the UL-SpatialFilter to the PUCCH resources configured with the indicated PUCCH resource group ID. If the MAC-CE is received with an UL BWP ID, the UL-SpatialFilter is applied to the said PUCCH resources configured only within the indicated UL BWP.

### Implicit Beam Indication for PUCCH Resources Grouped Via Higher Layer Configuration

For UEs satisfying beam correspondence, methods for implicit beam indication for PUCCH resources that follow the DL beam direction used for a CORESET are provided above. The implicit indication is enabled via a MAC-CE message indicating an ‘UL-SpatialFilter’ IE comprising a CORESET ID or CORESET group ID. In the following, alternative methods for implicit beam indication/beam determination for PUCCH resources via a higher layer configuration are provided, that help in faster beam indication/switch and thereby, reduced control information overhead.

In accordance with an embodiment, if the PUCCH resources are grouped explicitly via a higher layer configuration using CORESET ID values, the UE is configured to use the same spatial filter for the transmission of a group of PUCCH resources associated with a CORESET via higher layer configuration as for the reception of the PDCCH(s) on the CORESET. For example, if a group of PUCCH resources are associated with a CORESET c; via higher layer configuration, the UE uses the same spatial filter for the transmission of the group of PUCCH resources as for the reception of the PDCCH(s) on the CORESET cᵢ.

In accordance with an embodiment, if the PUCCH resources are grouped explicitly via a higher layer configuration using CORESET group ID values, the UE is configured to use the same spatial filter for the transmission of a group of PUCCH resources associated with a CORESET group via higher layer configuration as for the reception of the PDCCH(s) on one of the CORESETs in the CORESET group. For example, if a group of PUCCH resources are associated with the CORESET group gi via higher layer configuration and CORESETS cᵢ₁ and cᵢ₂ belong to the CORESET group gi, the UE uses the same spatial filter for the transmission of the group of PUCCH resources as for the reception of the PDCCH(s) on either the CORESET cᵢ₁ or CORESET cᵢ₂. In certain cases, there may be a default CORESET assumption for each CORESET group that the UE may use as a reference for the spatial filter to be used for the transmission of the PUCCH resources grouped with the said CORESET group ID value. For example, the CORESET with the lowest/highest CORESET ID value in the CORESET group may be taken as the default CORESET for spatial filter reference.

The above UE behavior may be enabled via a higher layer parameter so that in the case of UEs with beam correspondence, if the parameter is enabled, the UE derives the spatial filter for the group of PUCCH resources from the appropriate CORESET(s).

In accordance with an embodiment, the UE is configured by the gNB or any other network entity with a higher layer parameter that indicates whether the UE may use the same spatial filter as for the reception of the PDCCH(s) on a CORESET for the transmission of a group of PUCCH resources associated via higher layer configuration with the same CORESET or the same CORESET group as the one the CORESET belongs to.

### Implicit Beam Indication for PUCCH Resources Carrying HARQ ACK(s)/NACK(s)

Apart from the grouping strategies mentioned above, a dynamic update of the properties of UL resources without grouping is also possible as well, especially with PUCCH resources carrying HARQ ACK/NACK. According to the CORESET on which the PDCCH indicating the PUCCH resource to carry the HARQ ACK/NACK is transmitted, the beam directions can be implicitly indicated for PUCCH resources from the CORESET.

The PUCCH resources on which the ACK(s)/NACK(s) for PDSCH(s) are to be transmitted are indicated in the PDCCH scheduling the PDSCH. For UEs satisfying beam correspondence, the beam direction of the PUCCH resources, carrying HARQ ACK(s)/NACK(s), may follow the beam direction of the CORESET on which the PDCCH(s) indicating them are transmitted. Such UE behavior may be specified as default when the PUCCH resources are not indicated with a spatial filter/PUCCH spatial relation to be used. This UE behavior can also be facilitated with the help of a higher layer parameter which indicates if the PUCCH resources follow the beam direction used for the reception of the PDCCH(s) indicating them.

In accordance with an embodiment, the UE is configured to use the same spatial filter used for the reception of the PDCCH(s) on a CORESET for the transmission of PUCCH resource(s) indicated in the PUCCH resource indicator field of the PDCCH(s) transmitted on the CORESET.

In accordance with an embodiment, the UE is configured to use the same spatial filter used for the reception of the PDCCH(s) on a CORESET for the transmission of the PUCCH resource(s) indicated in the PUCCH resource indicator field of the PDCCH(s) transmitted on the CORESET when the PUCCH resource(s) is (are) not configured/indicated with a spatial filter.

In accordance with an embodiment, the UE is configured to receive from the gNB or any other network entity, a higher layer parameter that indicates whether the spatial filter used by the UE for the reception of the PDCCH(s) on a CORESET may be used for the transmission of the PUCCH resource(s) indicated in the PUCCH resource indicator field of the PDCCH(s) transmitted on the CORESET.

As example, the higher layer parameter may be titled as an ‘pucchSpatialFilterFollowsCORESET’ and may take the value ‘enabled’ or ‘disabled’. If the parameter ‘pucchSpatialFilterFollowsCORESET’ is set to ‘enabled’, the UE uses the same spatial filter used for the reception of the PDCCH(s) on the CORESET and the transmission of the PUCCH resources indicated by the PUCCH resource indicator field in the PDCCH(s) transmitted on the CORESET.

The beam direction for a PUCCH resource, in this method, is dynamically determined without the necessity of indicating the beam direction for each PUCCH resource, or a group of PUCCH resources via a MAC-CE message or an explicit grouping of PUCCH resources via a higher layer configuration.

The beam direction of PUCCH resources carrying HARQ ACK(s)/NACK(s) may also be enabled to implicitly follow the PDSCH for which they carry the ACK(s)/NACK(s). The beam direction of the PDSCH is indicated via a TCI state, and it may follow the beam direction of the CORESET on which the PDCCH scheduling the PDSCH is transmitted. Alternatively, the beam direction may be indicated by the PDCCH scheduling the PDSCH in a 3-bit TCI-state indication field. This UE behavior may be enabled as default when no spatial filter/spatial relation is indicated for a PUCCH resource or it can be enabled via a higher layer parameter.

In accordance with an embodiment, the UE is configured to use the same spatial filter used for the reception of a PDSCH for the transmission of the PUCCH resource(s) that carry the HARQ ACK/NACK for the PDSCH.

In accordance with an embodiment, the UE is configured to use the same spatial filter used for the reception of a PDSCH for the transmission of the PUCCH resource(s) that carry the HARQ ACK/NACK for the PDSCH, when the PUCCH resource(s) is (are) not configured/indicated with a spatial filter.

In accordance with an embodiment, the UE is configured to receive from the gNB or any other network entity, a higher layer parameter, that indicates whether the spatial filter used by the UE for the reception of a PDSCH may be used for the transmission of the PUCCH resource(s) that carry the HARQ ACK/NACK for the PDSCH. As an example, the parameter may be titled ‘pucchSpatialFilterFollowsPDSCH’, and may take the value ‘enabled’ or ‘disabled’. If the parameter ‘pucchSpatialFilterFollowsPDSCH’ is set to enabled, the UE uses the same spatial filter for the transmission of the PUCCH resource(s) carrying the HARQ ACK(s)/NACK(s) for a PDSCH as for the reception of the PDSCH.

### 2.2 Configuration and Indication of Power Control Parameters for UL Channels and Reference Signals

In this section, methods for configuration and indication of the power control settings for various UL channels/RSs in a way to reduce higher layer overhead and latency from the state of the art are introduced in accordance with some embodiments herein. The pathloss reference RSs, specifically, are discussed in detail. The redundancy in the configuration of the pathloss reference RSs is discussed first, followed by the introduction of methods to indicate the same via MAC-CE messages and PHY-layer signaling.

Each PUSCH/PUCCH/SRS pathloss reference RS IE/parameter in 3GPP Rel. 15 comprises a DL RS to be used as a pathloss reference. When a PUCCH/SRS resource or PUSCH is configured/indicated with a pathloss reference RS IE/parameter, the UE uses the DL RS indicated as the pathloss reference to derive the pathloss factor/estimate for the calculation of the transmit power of the said PUCCH/SRS resource or PUSCH. The pathloss reference RSs, are configured separately for PUCCH, SRS and PUSCH in 3GPP Rel. 15. Such a separate configuration results in a large signaling overhead since the same pathloss reference RS is configured for different UL channels and UL resources. Moreover, as the maximum number of pathloss reference RSs that can be configured for both PUSCH and PUCCH in 3GPP Rel. 15 is restricted as part of the UE's capability [6], frequent RRC reconfiguration of the pathloss reference RSs is performed when a UE moves within a cell. A common configuration of the pathloss reference RSs for PUCCH, and either SRS or PUSCH or both that avoids reconfigurations for each UL channel/RS is introduced in the following.

In accordance with embodiments, the UE is configured to receive, from the gNB or any other network entity, a higher layer configuration of a pathloss reference RS IE containing at least the following parameters: an ID unique for the pathloss reference RS and the ID of a DL RS, e.g., a CSI-RS resource or an SSB. The UE may use the IDs of the configured pathloss reference RS IEs in the IEs used to configure the power control settings for PUCCH and, either SRS or PUSCH or both. When PUSCH/SRS resource(s)/PUCCH resource(s) is (are) configured/indicated with power control settings containing the ID of a pathloss reference RS IE, the UE uses the DL RS configured in the said pathloss reference RS IE to derive the pathloss factor for the calculation of the transmit power for the UL transmission(s) of the said PUSCH/SRS resource(s)/PUCCH resource(s). The pathloss factor of subcarrier f in serving cell c is computed from the indicated pathloss reference RS q_{d} as PL_{f,c}(q_{d})=ReferenceSignalPower-RSRP, where RSRP is the higher layer filtered reference signal received power and where the ReferenceSignalPower is the transmit power of the pathloss reference RS provided by higher layers and the RSRP is computed by the physical layer and filtered by higher layers. The higher layer filter may be designed as described in [6].

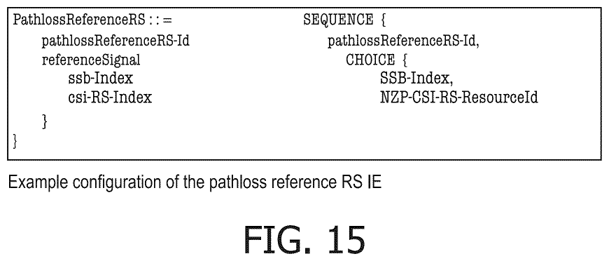

Having a common pathloss reference RS configuration for PUCCH, PUSCH and SRS instead of independent configurations for each of them also reduces the redundancy in RRC configuration. The UE may receive up to P≥1 pathloss reference RS configurations. An example configuration of the pathloss reference RS IE is provided in FIG. 15.

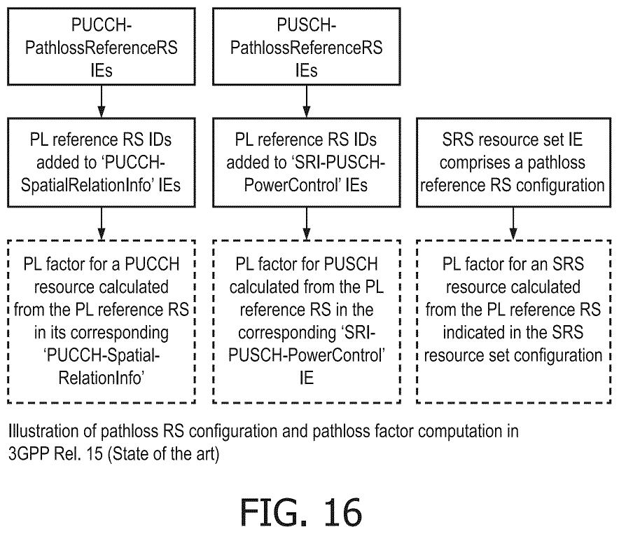

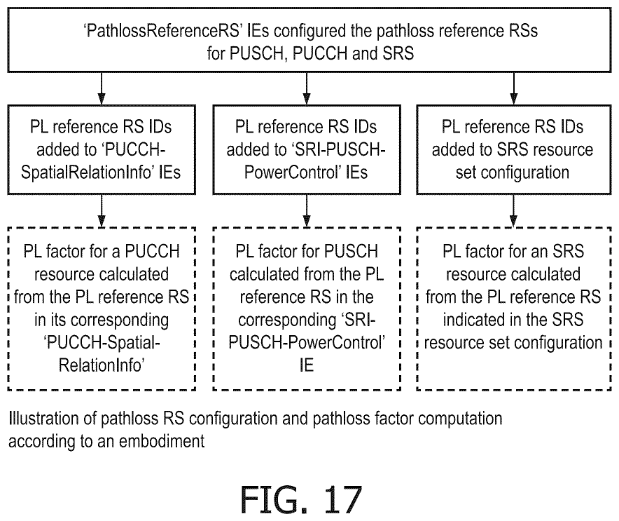

An illustration of how the pathloss reference RSs are configured in 3GPP Rel. 15 and how a version of the proposed common pathloss reference RS configuration may be implemented are shown in FIG. 16 and FIG. 17 respectively. As shown in FIG. 16, the pathloss reference RSs in 3GPP Rel. 15, are configured separately for PUCCH, and PUSCH and SRS (not shown). In FIG. 17, a common pathloss reference RS configuration for PUCCH, PUSCH and SRS is used. The figures shown are for the following cases of PUCCH, SRS and PUSCH:
The PUSCH is assumed to be scheduled in ‘codebook’ or ‘non-codebook’ transmission mode and the ‘SRS-resource-indicator’ used to schedule the PUSCH maps to a ‘SRI-PUSCH-PowerControl’ IE.
The PUCCH resource in the figures is associated with a ‘PUCCH-SpatialRelationInfo’ IE via a MAC-CE message.
The SRS resource in the figures belongs to an SRS resource set configured with a pathloss reference RS parameter.

### Pathloss Reference RS Update Via MAC-CE or PHY Signaling

The common configuration of the pathloss reference RSs addresses the redundancy in configuration of the pathloss reference RSs. However, when the list of pathloss reference RSs for the UE is reconfigured (for e.g., when the UE is moving in the cell and the gNB allocates a new set of beams for the UE to indicate pathloss reference(s)), the IEs that include the pathloss reference RSs such as ‘SRI-PUSCH-PowerControl’, ‘PUCCH-SpatialRelationInfo’, etc. would also need to be reconfigured. Therefore, to avoid reconfiguring all concerned IEs, the pathloss reference RSs may be updated for the required PUCCH/SRS resource and/or PUSCH via MAC-CE or PHY-signaling, thereby reducing the control overhead. The following embodiments describe signaling schemes for updating the introduced pathloss reference RSs for PUSCH, SRS and PUCCH via MAC-CE and PHY-layer messages.

In accordance with an embodiment, the UE is configured to receive a MAC-CE message from the gNB or any other network entity that contains at least a pathloss reference RS ID and the ID(s) of one or more SRS resource(s) or SRS resource set(s). When the UE receives the MAC-CE message, the UE uses the RS configured in the indicated pathloss reference RS IE to derive the pathloss factor for the calculation of the transmit power for the UL transmission of the indicated SRS resource(s) or all the SRS resources configured in the indicated SRS resource set(s).

The update of the pathloss reference RSs using MAC-CE messages for PUCCH may be performed with the pathloss reference RS configuration proposed above or with the existing 3GPP Rel. 15 configuration of the pathloss reference RSs for PUCCH-‘PUCCH-PathlossReferenceRS’.

In accordance with an embodiment, the UE is configured to receive a MAC-CE message from the gNB or any other network entity that contains at least a pathloss reference RS ID or the ID of at least one ‘PUCCH-PathlossReferenceRS’ according to 3GPP Rel. 15, and the ID(s) of one or more PUCCH resources. When the UE receives the MAC-CE message, the UE uses the DL RS configured in the indicated pathloss reference RS IE to derive the pathloss factor for the calculation of the transmit power for the UL transmission(s) of the indicated PUCCH resource(s).

The PUCCH resource grouping methods may be used to indicate the pathloss reference RS to be used for the transmission of a group of PUCCH resources.

In accordance with embodiments, the UE is configured to receive a MAC-CE message from the gNB or any other network entity that contains at least a pathloss reference RS ID or the ID of at least one ‘PUCCH-PathlossReferenceRS’ according to 3GPP Rel. 15, and a CORESET ID, or a CORESET group ID, or a PUCCH resource group ID. When the UE receives the MAC-CE message, the UE uses the RS configured in the indicated pathloss reference RS configuration to derive the pathloss factor for the calculation of the transmit power for an UL transmission of the group of PUCCH resource(s) associated with the indicated CORESET ID/CORESET group ID/PUCCH resource group ID via higher layer configuration or to any PUCCH resource(s) indicated via the PUCCH resource indicator field by PDCCH(s) transmitted on the indicated CORESET or on the CORESET(s) belonging to the indicated CORESET group.

The MAC-CE messages described may contain a serving cell ID to indicate the serving cell the MAC-CE message applies to. The messages may also be used to update the pathloss reference RS of PUCCH/SRS resources only in a specific UL-BWP. In certain cases, the UE may require that it update the pathloss reference RSs for PUCCH/SRS only within the active BWP or a BWP it might switch to and not for all the PUCCH/SRS in the whole cell. The inclusion of the UL-BWP provides the option to update the pathloss reference RS for only a subset of the PUCCH resources in the cell.

In accordance with an embodiment, the MAC-CE message received by the UE from a gNB or any other network entity to update the pathloss reference RS for a PUSCH, or one or more or a group of PUCCH/SRS resources, may contain an UL BWP ID and a serving cell ID. If the UE receives the MAC-CE message with an UL-BWP ID, the UE uses the RS configured in the indicated pathloss reference RS configuration to derive the pathloss factor for the calculation of the transmit power for an UL transmission of the said PUSCH or PUCCH/SRS resources in the indicated UL BWP of the indicated serving cell.

In addition to the MAC-CE-based indication of the pathloss reference RS, a physical layer indication of the same via a PDCCH can be performed for PUCCH and/or PUSCH.

In accordance with an embodiment, the UE is configured to receive from the gNB or any other network entity, a PDCCH containing a pathloss reference RS indicator field, whose value maps to one of the higher-layer-configured pathloss reference RS IEs or at least one higher layer configured ‘PUCCH-PathlossReferenceRS’ ID according to 3GPP Rel. 15. When the UE receives the PDCCH, it uses the RS configured in the indicated pathloss reference RS IE to derive the pathloss factor for the calculation of the transmit power for an UL transmission of the PUCCH resource indicated by the PUCCH resource indicator field in the PDCCH or the PUSCH scheduled by the PDCCH.

When the PUSCH is scheduled by a PDCCH with DCI format 0_1, the higher layer parameter SRI-PUSCH-PowerControl provides the power control settings for the PUSCH transmission [4, 6]. The sounding reference signal indicator (SRI) in the DCI that indicates the ports of the SRS resource that need to be used to transmit the PUSCH, maps to one of the power control parameters, i.e., ‘SRI-PUSCH-PowerControl’ IEs, that contains the pathloss reference RS as well. In the case of mobility, if the pathloss reference RS has to be modified, RRC reconfiguration of the ‘SRI-PUSCH-PowerControl’ parameters would be required that increases latency of the pathloss RS update.

In the following, methods for MAC-CE-based pathloss reference RS update for PUSCH that would support higher mobility are introduced. And the MAC-CE messages may use the pathloss reference RSs that are configured as described above or use the PUSCH pathloss reference RS configuration in 3GPP Rel. 15.

In accordance with embodiments, the UE is configured to receive a MAC-CE message from the gNB or any other network entity to update the pathloss reference RS of a PUSCH. The MAC-CE message contains at least a pathloss reference RS ID or at least one ‘PUSCH-PathlossReferenceRS’ ID according to 3GPP Rel. 15, and a UL BWP ID. When the UE receives the MAC-CE message, the UE uses the RS configured in the indicated pathloss reference RS configuration to derive the pathloss factor for the calculation of the transmit power for an UL transmission of the PUSCH in the indicated UL BWP.

In accordance with embodiments, the UE is configured to receive a MAC-CE message from the gNB or any other network entity that contains at least a pathloss reference RS ID or at least one ‘PUSCH-PathlossReferenceRS’ ID according to 3GPP Rel. 15, and an SRI-PUSCH-PowerControl ID. When the UE receives the MAC-CE message, the UE updates the pathloss reference RS to be used with the indicated ‘SRI-PUSCH-PowerControl’ IE with the pathloss reference RS indicated in the MAC-CE message.

In accordance with embodiments, the UE is configured to receive a MAC-CE message from the gNB or any other network entity that contains at least a pathloss reference RS ID or at least one ‘PUSCH-PathlossReferenceRS’ ID according to 3GPP Rel. 15, and the value of a sounding reference signal index/indicator (SRI). When the UE receives the MAC-CE message, the UE uses the RS configured in the indicated pathloss reference RS configuration to derive the pathloss factor for the calculation of the transmit power for an UL transmission of a PUSCH scheduled with the indicated SRI value via the PDCCH or a configured UL grant.

### Implicit Pathloss Reference RS Indication Using a CORESET

Explicit configuration and indication of the pathloss reference RSs is usually performed in 3GPP Rel. 15 when the UE operates at frequency range 2 (FR2). For PUCCH, the pathloss reference RSs are configured and included in ‘PUCCH-SpatialRelationInfo’ IEs. A specific ‘PUCCH-SpatialRelationInfo’ IE is indicated for each PUCCH resource via a MAC-CE message. In case of the SRS, the pathloss reference RS is explicitly configured per SRS resource set when the UE operates at FR2. For PUSCH, a list of pathloss reference RSs are configured via a higher layer and included in ‘SRI-PUSCH-PowerControl’ IEs. When a PUSCH is scheduled, a mapping from the SRI used to schedule the PUSCH to the ‘SRI-PUSCH-PowerControl’ IEs determines the pathloss reference RS.

When the UE is moving within a cell, the DL beam used to receive a DL channel may change frequently. This may lead to permanent higher layer re-configurations of the pathloss reference RSs used to derive the UL transmission power. Such frequent re-configurations increase the signaling overhead and reduce the overall network efficiency.

The following embodiments provide schemes for implicit indication of the pathloss reference RS which are based on the TCI-state indication of a DL channel by the gNB. Such implicit indication avoids the frequent re-configuration and explicit indication of the pathloss reference using DL RSs when the UE is moving within a cell thereby reducing signaling overhead and latency of pathloss reference RS indication.

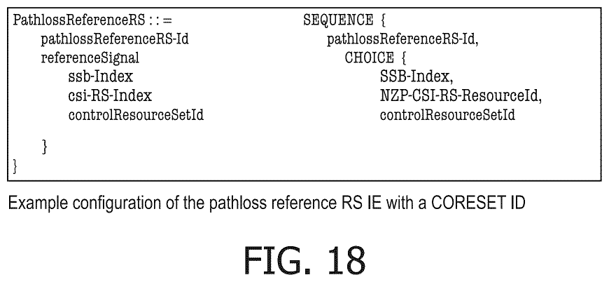

In accordance with an embodiment, the UE is configured to receive from the gNB or any other network entity, a higher layer configuration of a pathloss reference RS IE or a PUCCH/PUSCH/SRS pathloss reference RS IE/parameter according to 3GPP Rel. 15 comprising a CORESET ID. An example configuration of the pathloss reference RS IE containing a CORESET ID is shown in FIG. 18. When a PUSCH or PUCCH or SRS is configured/indicated with a CORESET as a pathloss reference, the UE uses the DL RS configured with ‘qcl-TypeD’ in the TCI-state of the CORESET as pathloss reference RS to derive the pathloss factor for the calculation of the transmit power for an UL transmission of the said PUSCH or PUCCH or SRS.

When the UE receives a MAC-CE message indicating a pathloss reference RS configuration containing a CORESET ID for one or more PUCCH/SRS resource(s) or PUSCH, the UE uses the DL RS configured with ‘qcl-TypeD’ in the TCI-state of the CORESET to derive the pathloss factor for the calculation of the transmit power for an UL transmission of the said PUCCH/SRS resource(s) or PUSCH. At every instance the TCI-state for the CORESET is updated, the UE also updates the pathloss reference RS of the said PUCCH/SRS resources or PUSCH with the DL RS configured with ‘qcl-TypeD’ in the TCI-state of the CORESET. This implicit indication of the pathloss reference RS allows the UE to follow the DL Rx beam for pathloss reference thereby eliminating the explicit signaling of the same whenever there is a change in the DL beam.

### Implicit Pathloss Reference RS Derivation for PUCCH Resources Carrying HARQ ACK(s)/NACK(s)

The implicit derivation of the pathloss reference RS may be performed for PUCCH resources carrying the HARQ ACK(s)/NACK(s) from the CORESET on which the PDCCH(s) indicating them are transmitted. This implicit derivation may be performed by the UE when the UE is configured via a higher layer indication or when there is no configuration/indication of a pathloss reference RS for the PUCCH resource.

In accordance with an embodiment, the UE is configured to use the DL RS configured with ‘qcl-TypeD’ in the TCI-state of a CORESET to derive the pathloss factor for the calculation of the transmit power for an UL transmission of the PUCCH resource(s) indicated by the PUCCH resource indicator field in the PDCCH(s) transmitted on the CORESET.

In accordance with an embodiment, the UE is configured to use the DL RS configured with ‘qcl-TypeD’ in the TCI-state of a CORESET to derive the pathloss factor for the calculation of the transmit power for an UL transmission of the PUCCH resource(s) indicated by the PUCCH resource indicator field in the PDCCH(s) transmitted on the CORESET, when there is no configuration/indication of pathloss reference RS(s) of the PUCCH resource(s).

In accordance with an embodiment, the UE is configured to receive, from the gNB or any other network entity, a higher layer parameter to indicate whether the UE may use the DL RS, configured with ‘qcl-TypeD’, in the TCI-state of a CORESET to derive the pathloss factor for the calculation of the transmit power for an UL transmission of the PUCCH resources indicated by the PUCCH resource indicator field in the PDCCH(s) transmitted on the CORESET. The parameter may be titled ‘PUCCHPLRefRSfromCORESET’, for example, and its possible values may be ‘enabled’ and ‘disabled’. When the parameter is set to ‘enabled’, the UE uses the DL RS configured with ‘qcl-TypeD’ in the TCI-state of a CORESET to derive the pathloss factor for the calculation of the transmit power for an UL transmission of the PUCCH resources indicated by the PUCCH resource indicator field in the PDCCH(s) transmitted on the CORESET.

A similar scheme may be applied in the case of PDSCH to enable to PUCCH resource carrying the HARQ ACK/NACK for the PDSCH to derive the pathloss reference RS from the TCI-state of the PDSCH.

In accordance with an embodiment, the UE is configured to use the DL RS configured with ‘qcl-TypeD’ in the TCI-state of a PDSCH to derive the pathloss factor for the calculation of the transmit power for an UL transmission of the PUCCH resource(s) that carries the HARQ ACK(s)/NACK(s) for the PDSCH.

In accordance with an embodiment, the UE is configured to use the DL RS configured with ‘qcl-TypeD’ in the TCI-state of a PDSCH to derive the pathloss factor for the calculation of the transmit power for an UL transmission of the PUCCH resource(s) that carries the HARQ ACK(s)/NACK(s) for the PDSCH, when there is no configuration/indication of pathloss reference RS(s) of the PUCCH resource(s).

In accordance with an embodiment, the UE is configured to receive, from the gNB or any other network entity, a higher layer parameter to indicate whether the UE shall use the DL RS configured with ‘qcl-TypeD’ in the TCI-state of a PDSCH to derive the pathloss factor for the calculation of the transmit power for an UL transmission of the PUCCH resource that carries the HARQ ACK(s)/NACK(s) for the PDSCH. The parameter may be titled ‘PUCCHPLReferenceRSfromPDSCH’, for example, and its possible values may be ‘enabled’ and ‘disabled’. When the parameter is set to ‘enabled’, the UE uses the DL RS configured with ‘qcl-TypeD’ in the TCI-state of a PDSCH to derive the pathloss factor for the calculation of the transmit power for an UL transmission of the PUCCH resource that carries the HARQ ACK(s)/NACK(s) for the PDSCH.

### Implicit Pathloss Reference RS Derivation for Grouped PUCCH Resources

Implicit pathloss reference RS derivation may also be performed in the case of PUCCH resources that have been explicitly grouped using a CORESET ID or a CORESET group ID.

In accordance with an embodiment, the UE is configured to use the DL RS configured with ‘qcl-TypeD’ in the TCI-state of a CORESET to derive the pathloss factor for the calculation of the transmit power for an UL transmission of a group of PUCCH resources associated with the CORESET via higher layer configuration.

In accordance with an embodiment, the UE is configured to use the DL RS configured with ‘qcl-TypeD’ in the TCI-state of one of the CORESETs in a CORESET group to derive the pathloss factor for the calculation of the transmit power for an UL transmission of a group of PUCCH resources associated with the CORESET group via higher layer configuration. For example, a default CORESET such as the CORESET with the lowest/highest CORESET ID in a CORESET group may be assumed for the choice of pathloss reference RS source.

In accordance with an embodiment, the UE is configured by the gNB or any other network entity to receive a higher layer parameter to indicate whether the UE shall use the DL RS configured with ‘qcl-TypeD’ in the TCI-state of a CORESET as the pathloss reference RS of a group of PUCCH resources associated with the CORESET or associated with the same CORESET group as the CORESET via higher layer configuration. The parameter may be titled ‘pucchGroupingPLRefRSAssumption’, for example, and may take values ‘enabled’ and ‘disabled’. When the parameter is set to ‘enabled’, the UE uses the DL RS configured with ‘qcl-TypeD’ in the TCI-state of a CORESET as the pathloss reference RS of a group of PUCCH resources associated with the CORESET or associated with the same CORESET group as the CORESET via higher layer configuration.

### Configuration and Indication of Power Control Settings for PUCCH

In 3GPP Rel. 15, the power control settings for PUCCH resources are configured along with the UL beam direction RS in ‘PUCCH-SpatialRelationInfo’. As mentioned before, combining the configuration of power control and beam directions is inefficient in addressing the different needs of beam direction indication for UEs with differing beam correspondence capabilities. Moreover, decoupling of the power control parameters that may not change with UE mobility from the ones that change helps in reducing unnecessary RRC signaling. In the following embodiments, methods to configure power control settings separate from the beam direction settings and methods to decouple pathloss reference RSs from the rest of the power control settings are provided.

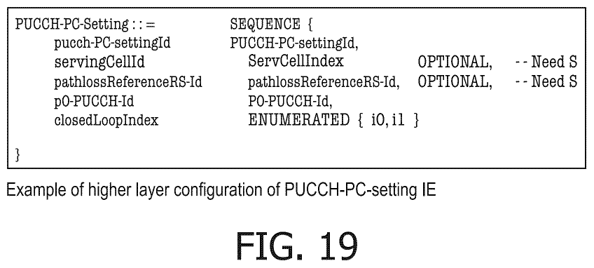

In accordance with an embodiment, the UE is configured to receive from the gNB or any other network entity, an information element via a higher layer of one or more power control settings for the PUCCH, wherein a power control setting contains at least the following parameters: an ID unique for each power control setting IE, a closed loop power control index, a p0-PUCCH-ID and optionally the ID of a pathloss reference RS. The parameter might be titled as ‘PUCCH-PC-setting’, for example, (PC stands for Power Control). An example configuration of the IE is shown in FIG. 19.

In accordance with an embodiment, the UE is configured to receive from the gNB or any other network entity, a MAC-CE message containing at least the following parameters: a ‘PUCCH-PC-setting’ ID and one or more PUCCH resource IDs. When the UE receives the said MAC-CE message, the UE applies the power control settings indicated by the PUCCH-PC-setting to the PUCCH resource(s) indicated in the MAC-CE message, i.e., the UE uses the power control settings indicated in the MAC-CE message, to derive the transmit power for the said PUCCH resources in an UL transmission.

The transmission power may be derived using the power control parameters in the ‘PUCCH-PC-setting’ with the formula for P_{PUCCH} provided in [3].

In another alternative, since the pathloss reference RSs change due to UE mobility, the indication of the pathloss reference RSs can be performed via MAC-CE messages. The MAC-CE used to update the pathloss reference RS for PUCCH may indicate one of the pathloss reference RS IEs introduced above or one of the PUCCH pathloss reference RS IEs configured according to 3GPP Rel. 15.

In accordance with an embodiment, the UE is configured to receive from the gNB or any other network entity, a MAC-CE message containing at least the following parameters: a ‘PUCCH-PC-setting’ ID, a pathloss reference RS ID or at least one ‘PUCCH-PathlossReferenceRS’ ID according to 3GPP Rel. 15, and one or more PUCCH resource IDs. When the UE receives the MAC-CE message, the UE uses the power control settings in the PUCCH-PC-setting and the indicated pathloss reference RS to derive the transmission power of the said PUCCH resources. If the ‘PUCCH-PC-setting’ indicated in the MAC-CE message is configured with a pathloss reference RS, the UE replaces the same with the pathloss reference RS indicated in the MAC-CE message.

In accordance with an embodiment, the UE is configured to receive from the gNB or any other network entity, a MAC-CE message containing at least the following parameters: a ‘PUCCH-PC-setting’ ID, one or more PUCCH resource IDs, a UL-SpatialFilter ID, and optionally, a pathloss reference RS ID. When the UE receives the MAC-CE message with a pathloss reference RS ID or the PUCCH reference RS ID according to 3GPP Rel. 15, the UE applies the indicated UL-SpatialFilter to the indicated PUCCH resources and the power control settings in the indicated PUCCH-PC-setting and the indicated pathloss reference RS are used to derive the transmit power for the indicated PUCCH resources. If the ‘PUCCH-PC-setting’ indicated in the MAC-CE message is configured with a pathloss reference RS, the UE replaces the same with the pathloss RS indicated in the MAC-CE message. When the UE receives the MAC-CE message without the pathloss reference RS ID, the UE applies the indicated UL-SpatialFilter and the power control settings indicated in ‘PUCCH-PC-setting’ to the indicated PUCCH resources, and the pathloss reference RS for the indicated PUCCH resources is obtained from one of the following by the UE:
the pathloss reference RS configured in the PUCCH-PC-setting indicated in the MAC-CE message, or
the DL RS configured in the ‘UL-SpatialFilter’ IE indicated in the MAC-CE message, or
when the indicated UL-SpatialFilter is configured with a CORESET ID, the DL RS configured with ‘qcl-typeD’ in the TCI-state of the said CORESET.

With a decoupled indication of the pathloss reference RSs and the ‘PUCCH-PC-setting’ IEs that contain the power control settings that may remain constant as the UE moves within the cell, the control information overhead is reduced. The updates of parameters that remain unchanged with UE mobility need not be reconfigured as a consequence. Moreover, a flexible MAC-CE-based update of multiple higher-layer-configured PUCCH transmission settings (pathloss reference RS, PUCCH-PC-settings, spatial filter) is introduced. This leads to lower latency in the update of the transmission settings for the said PUCCH resources.

Update of power control, pathloss reference and/or spatial filter for a group of PUCCH resources

The methods used to group PUCCH resources via higher layer configuration may be exploited to update their power control settings as described above. In the following, various methods for the update of the power control settings for a group of PUCCH resources via MAC-CE messages are provided.

In accordance with an embodiment, the UE is configured to receive from the gNB or any other network entity, a MAC-CE message containing at least the following parameters: a ‘PUCCH-PC-setting’ ID and a CORESET ID or CORESET group ID or a PUCCH resource group ID. When the UE receives the said MAC-CE message, the UE uses the power control settings indicated by the PUCCH-PC-setting to derive the transmit power of the PUCCH resource(s) associated with the indicated CORESET or CORESET group or PUCCH resource group via higher layer configuration.

For pathloss reference RS updates performed via MAC-CE messages, the ‘PUCCH-PathlossReferenceRS’ IEs configured according to 3GPP Rel. 15 may also be used.

In accordance with an embodiment, the UE is configured to receive from the gNB or any other network entity, a MAC-CE message containing at least the following parameters: a ‘PUCCH-PC-setting’ ID, a pathloss reference RS ID or a ‘PUCCH-PathlossReferenceRS’ ID according to 3GPP Rel. 15 and, a CORESET ID or a CORESET group ID or a PUCCH resource group ID. When the UE receives the MAC-CE message, the UE uses the power control settings in the PUCCH-PC-setting and the pathloss reference RS indicated in the MAC-CE to derive the transmit power of the PUCCH resources associated with the indicated CORESET or CORESET group or PUCCH resource group via higher layer configuration. If the ‘PUCCH-PC-setting’ indicated in the MAC-CE message is configured with a pathloss reference RS, the UE replaces the same with the pathloss reference RS indicated in the MAC-CE message.

In accordance with an embodiment, the UE is configured to receive from the gNB or any other network entity, a MAC-CE message containing at least the following parameters: a ‘PUCCH-PC-setting’ ID, a UL-SpatialFilter ID, a CORESET ID or a CORESET group ID or a PUCCH resource group ID, and optionally, a pathloss reference RS ID or the ‘PUCCH-PathlossReferenceRS’ according to 3GPP Rel. 15. When the UE receives the MAC-CE message with the pathloss reference RS ID or the ‘PUCCH-PathlossReferenceRS’ according to 3GPP Rel. 15, the UE applies the indicated UL-SpatialFilter to the indicated PUCCH resources and the power control settings from the indicated PUCCH-PC-setting and the indicated pathloss reference RS are used to derive the transmit power of the PUCCH resource(s) associated with the indicated CORESET or CORESET group or PUCCH resource group via higher layer configuration. If the ‘PUCCH-PC-setting’ indicated in the MAC-CE message is configured with a pathloss reference RS, the UE replaces the same with the pathloss RS indicated in the MAC-CE message. When the UE receives the MAC-CE message without the pathloss reference RS ID, the UE applies the indicated UL-SpatialFilter and the power control settings indicated in ‘PUCCH-PC-setting’ for the transmission of the said PUCCH resources, and the pathloss reference RS for the said PUCCH resources is obtained from one of the following by the UE:
the pathloss reference RS configured in the PUCCH-PC-setting indicated in the MAC-CE message, or
the DL RS configured in the ‘UL-SpatialFilter’ IE indicated in the MAC-CE message, or
when the MAC-CE message contains a CORESET ID, the DL RS configured with ‘qcl-typeD’ in the TCI-state of the indicated CORESET.
when the MAC-CE message contains a CORESET group ID, the DL RS configured with ‘qcl-typeD’ in the TCI-state of one of the CORESETs in the indicated CORESET group.
   Usage of the Proposed Methods with 3GPP Rel. 15-Based Configuration of the Pathloss Reference RSs

The proposed methods for the MAC-CE-based indication of the pathloss reference RSs for PUSCH and PUCCH, and the usage of a CORESET as a pathloss reference are compatible with 3GPP Rel. 15 configuration of the pathloss reference RSs for PUSCH and PUCCH as described in the respective methods. However, in the case of SRS, there is no list of pathloss reference RSs configured in 3GPP Rel. 15 to be indicated via MAC-CE messages. Each SRS resource set is configured with its own pathloss reference RS parameter. Therefore, for the proposed MAC-CE based update of the pathloss reference RS for the SRS to be used along with pathloss reference RS configuration according to 3GPP Rel. 15, a list of pathloss reference RSs for SRS may be configured.

In accordance with an embodiment, the UE is configured to receive from the gNB or any other network entity, SRS pathloss reference RS IE via a higher layer containing at least the following parameters: an ID unique for the SRS pathloss reference RS and the ID of a DL RS, e.g., a CSI-RS resource or an SSB or a CORESET. The UE may receive up to P_{SRS}≥1 pathloss RS configurations.

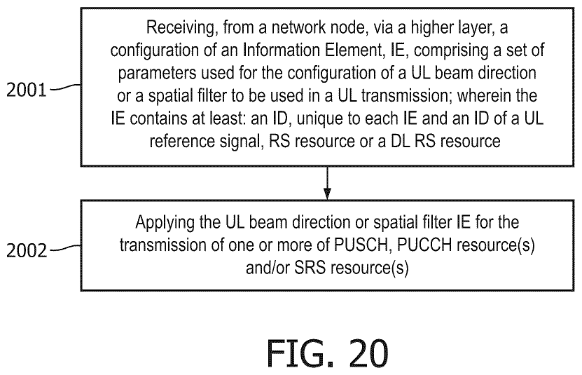

Referring to FIG. 20, there is illustrated a method performed by a UE according to some of previously described. The method comprises:
Receiving (2001), from a network node, via a higher layer, a configuration of an IE, comprising a set of parameters used for the configuration of an UL, beam direction or a spatial filter to be used in a UL transmission; wherein the IE contains at least: an ID, unique to each IE and an ID of an UL RS resource or a DL, RS resource; and
applying (2002) the UL beam direction or spatial filter IE for the transmission of one or more of the PUSCH, PUCCH resource(s) and/or SRS resource(s).

As previously described and in according to an embodiment, applying the UL beam direction or spatial filter IE includes:
If an SRS resource or PUCCH resource or a PUSCH is applied with a UL beam direction or spatial filter IE that contains an non-zero-power, NZP CSI-RS-Resource-Id, the said SRS resource or PUCCH resource or PUSCH is transmitted by the UE with the same spatial filter or beam direction used to receive the NZP CSI-RS resource;
If an SRS resource or PUCCH resource or a PUSCH is applied with a UL beam direction or spatial filter IE that contains an synchronization signal block, SSB, index, the said SRS resource or PUCCH resource or PUSCH is transmitted by the UE with the same spatial filter or beam direction used to receive the SSB resource;
If an SRS resource or PUCCH resource or PUSCH is applied with a UL beam direction or spatial filter IE that contains the ID of an SRS resource, the said SRS resource or PUCCH resource or PUSCH is transmitted with the same spatial filter or beam direction used to transmit the SRS resource indicated in the beam direction IE.

According to an embodiment, in case the UL resource used to indicate the beam direction or spatial filter in the IE is an SRS resource, the ID of an UL bandwidth part, BWP, on which the SRS is transmitted is further included in the IE received by the UE.

According to an embodiment, the method comprises receiving, from the network node, a MAC-CE, message containing the ID of at least one PUCCH resource or SRS resource and the ID of at least one UL beam direction or spatial filter IE; and applying the spatial filter used for the transmission of the UL RS resource or the reception of the DL RS resource configured in the indicated UL beam direction or spatial filter IE for the transmission of the indicated PUCCH resource(s) or SRS resource(s).

The ID of the UL beam direction or spatial filter IE used in the MAC-CE message is indicated via a bitmap, and wherein each bit in the bitmap is associated with one of the configured IEs.

According to an embodiment, the method comprises receiving, from the network node, a UL beam direction or spatial filter IE that comprises a CORESET ID to indicate the beam direction instead of a DL or a UL RS; and applying the UL beam direction or spatial filter IE comprising a CORESET ID to one or more of PUCCH resource(s), SRS resource(s) and/or PUSCH which involves the transmission of the said PUCCH resource(s), SRS resources(s), PUSCH with the same spatial filter as the one used for the reception of PDCCH(s) transmitted on the CORESET.

The method further comprises the transmission of the PUCCH resource(s), SRS resource(s), PUSCH with the spatial filter used for the most recent reception of the PDCCH(s) transmitted on the CORESET.

According to an embodiment, the method further comprises receiving, from the network node, a MAC-CE message comprising the ID of a UL beam direction or spatial filter IE that contains a CORESET ID, and the ID of at least one SRS resource or PUCCH resource; and applying the UL beam direction or spatial filter IE to the SRS resource(s) or PUCCH resource(s) indicated in the MAC-CE message.

The method further comprises receiving, from the network node, a PDCCH, that schedules a PUSCH containing an x-bit field, wherein the x-bit field indicates a UL beam direction or spatial filter IE, and applying the indicated UL beam direction or spatial filter IE to the scheduled PUSCH.

The method further comprises receiving, from the network node, a higher layer configured uplink grant that schedules a PUSCH containing the ID of a UL beam direction or spatial filter IE; and applying the indicated UL beam direction or spatial filter IE to the PUSCH scheduled by the uplink grant.

According to another embodiment, a method performed by a UE comprises receiving, from a network node, a higher layer configuration of at least one downlink RS as a pathloss reference in an IE containing at least the following parameters: an ID unique for the pathloss reference RS and the ID of a DL, Reference Signal, RS; and using said pathloss reference RSs in the configuration of the power control setting(s) and/or in the indication of the pathloss reference for PUCCH resource(s) and either SRS resource(s) or PUSCH or both.

The method further comprises receiving a MAC-CE message, from the network node, containing at least a pathloss reference RS ID or the ID of at least a ‘PUCCH-PathlossReferenceRS’ according to 3GPP Release 15, and the ID(s) of one or more PUCCH resources; and using the DL RS configured in the pathloss reference RS indicated by the MAC-CE message to derive a pathloss factor for calculating the transmit power for the UL transmission of the indicated PUCCH resources.

The method further comprises receiving, from the network node, a PDCCH, containing a pathloss reference RS indicator field whose value maps to one of the at least one higher layer configured pathloss reference RS IE or at least one higher layer configured ‘PUCCH-PathlossReferenceRS’ ID according to 3GPP Release 15; and using the RS configured in the at least one indicated pathloss reference RS IE or the ‘PUCCH-PathlossReferenceRS’ ID according to 3GPP Release 15 to derive a pathloss factor for the calculation of a transmit power for an UL transmission of a PUCCH resource indicated by a PUCCH resource indicator field in the PDCCH.

The method may further comprise receiving, from the network node, a PDCCH containing a pathloss reference RS indicator field whose value maps to one of the at least one higher layer configured pathloss reference RS IE or at least one higher layer configured ‘PUSCH-PathlossReferenceRS’ ID according to 3GPP Release 15; and using the RS configured in the at least one indicated pathloss reference RS IE or the ‘PUSCH-PathlossReferenceRS’ IE according to 3GPP Release 15 to derive a pathloss factor for the calculation of a transmit power for an UL transmission of a PUSCH, scheduled by the PDCCH.

The method may further comprise, receiving, from the network node, a PDCCH containing a pathloss reference RS indicator field whose value maps to one of the at least one higher layer configured pathloss reference RS IE or at least one higher layer configured ‘PUSCH-PathlossReferenceRS’ ID according to 3GPP Release 15; and using the RS configured in the at least one indicated pathloss reference RS IE or the ‘PUSCH-PathlossReferenceRS’ IE according to 3GPP Release 15 to derive a pathloss factor for the calculation of a transmit power for an UL transmission of a Physical Uplink Shared Channel, PUSCH, scheduled by the PDCCH.

According to an embodiment, the method may further comprise, receiving, from the network node, a pathloss reference RS IE comprising a CORESET ID or a PUCCH/PUSCH/SRS pathloss reference RS parameter/IE according to 3GPP Release 15 comprising a CORESET ID; and when a PUSCH and/or PUCCH resource(s) and/or SRS resource(s) are configured/indicated with a CORESET as a pathloss reference, using the DL RS, configured with ‘qcl-TypeD’ in a TCI-state, indicated for the CORESET, as pathloss reference RS to derive the pathloss factor for the calculation of the transmit power for an UL transmission of the said PUSCH and/or PUCCH resource(s) and/or SRS resource(s).

According to an embodiment, the method may further comprise, the updating of the pathloss reference RS of said PUCCH resource(s) and/or SRS resource(s) and/or PUSCH with the DL RS configured with ‘qcl-TypeD’ in the TCI-state of a CORESET at every instance the TCI-state of the CORESET is updated.

According to an embodiment, the method may comprise receiving, from the network node, a MAC-CE message containing at least one pathloss reference RS ID or at least one ‘PUSCH-PathlossReferenceRS’ ID according to 3GPP Release 15, and a SRI-PUSCH-PowerControl ID; and updating the pathloss reference RS to be used with the indicated ‘SRI-PUSCH-PowerControl’ IE with the pathloss reference RS indicated by the MAC-CE message.

According to an embodiment, the method may comprise receiving, from the network node, a MAC-CE message containing at least one pathloss reference RS ID or at least one ‘PUSCH-PathlossReferenceRS’ ID according to 3GPP Release 15, and an UL bandwidth part, BWP, ID; and using the RS configured in the indicated pathloss reference RS to derive the pathloss factor for the calculation of the transmit power for an UL transmission of the PUSCH

According to an embodiment the method may comprise receiving, from the network node, a MAC-CE message containing at least one pathloss reference RS ID or at least one ‘PUSCH-PathlossReferenceRS’ ID according to 3GPP Release 15 and the value of a sounding reference signal index/indicator, SRI, and using the RS configured in the indicated pathloss reference RS to derive a pathloss factor for the calculation of a transmit power for an UL transmission of the PUSCH if the PUSCH transmission is scheduled with the indicated SRI value in a DCI or an uplink configured grant.

The method may comprise receiving a MAC-CE message, from the network node, containing at least a pathloss reference RS ID and ID(s) of one or more SRS resources or SRS resource sets, and using the DL RS configured in the pathloss reference RS IE to derive the pathloss factor for calculating the transmit power for an UL transmission of the indicated SRS resources or all the SRS resources in the indicated SRS resource sets.

According to an embodiment, a method performed by a UE comprises receiving from the network node, a higher layer configuration of a grouping/association of PUCCH resources: using CORESET ID values or CORESET group ID values, or by using a PUCCH resource group identifier, PUCCH resource group ID, that is derived from the transmit/receive point (TRP) the PUCCH resources are associated with.

If PUCCH resources are grouped via a higher layer configuration using CORESET ID values, the UE uses the same spatial filter for the transmission of the group of PUCCH resources associated with a CORESET via higher layer configuration as for the reception of the PDCCH(s) on the CORESET. The method further comprises transmission of the PUCCH resources with the spatial filter used for the most recent reception of the PDCCH(s) transmitted on the CORESET

If PUCCH resources are grouped via a higher layer configuration using CORESET group ID values, the UE uses the same spatial filter for the transmission of the group of PUCCH resources associated with a CORESET group via higher layer configuration as for the reception of the PDCCH(s) on one of the CORESETs belonging to the CORESET group. According to an embodiment, the method comprises the transmission of the PUCCH resource(s) with the spatial filter used for the most recent reception of the PDCCH(s) transmitted on the said CORESET in the CORESET group.

According to an embodiment, the method further comprises receiving, from a network node, a higher layer parameter that indicates whether the UE shall use the same spatial filter for the reception of the PDCCH(s) on a CORESET and the transmission of a group of PUCCH resources associated via higher layer configuration with the CORESET or the CORESET group the CORESET belongs to.

If PUCCH resources are grouped via a higher layer configuration using CORESET ID values, the UE uses a DL RS configured with ‘qcl-TypeD’ in a TCI-state of a CORESET to derive a pathloss factor for the calculation of a transmit power for an UL transmission of the group of PUCCH resources associated with the CORESET via higher layer configuration.

Instead, if PUCCH resources are grouped via a higher layer configuration using CORESET group ID values, the UE uses the DL RS configured with ‘qcl-TypeD’ in the TCI-state of one of the CORESETs in a CORESET group to derive the pathloss factor for the calculation of the transmit power for an UL transmission of the group of PUCCH resources associated with the CORESET group via higher layer configuration.

According to an embodiment, the method comprises receiving, from the network node, a higher layer parameter to indicate whether the UE shall use the DL RS configured with ‘qcl-TypeD’ in the TCI-state of a CORESET as the pathloss reference RS of a group of PUCCH resources associated via higher layer configuration with the CORESET or the CORESET group the CORESET belongs to.

According to an embodiment, the method comprises receiving, from a network node, via higher layer, a configuration of an IE comprising a set of parameters used for configuration of an UL beam direction or the spatial filter to be used in a UL transmission; wherein the IE contains at least: an identifier, ID, unique to each IE and an ID of an uplink, UL reference signal, RS resource or a downlink, DL, RS resource; and applying the UL beam direction or spatial filter IE for the transmission of one or more of the PUSCH, PUCCH resource(s) and/or SRS resource(s) which includes: transmission of the said PUSCH and/or PUCCH resource(s) and/or SRS resource(s) with the same spatial filter as the one used for the reception of the DL RS resource or the transmission of the UL RS resource contained in the UL beam direction or spatial filter IE.

According to an embodiment, the method comprises receiving, from the network node, a MAC-CE message that contains at least the following: a serving cell ID, a CORESET ID or a CORESET group ID or a PUCCH resource group ID, an ID of a UL beam direction or spatial filter IE and optionally, an UL BWP ID.

When the UE receives the MAC-CE message with a CORESET ID or a CORESET group ID and without an UL BWP ID, the UE applies the UL beam direction or spatial filter IE to the PUCCH resources associated with the indicated CORESET or CORESET group via higher layer configuration or to any PUCCH resource(s) indicated via the PUCCH resource indicator field by PDCCH(s) transmitted on the indicated CORESET or on the CORESET(s) belonging to the indicated CORESET group, and wherein the serving cell ID indicates the cell the MAC-CE message is intended for.

When the UE receives the MAC-CE message with a PUCCH resource group ID and without an UL BWP ID, the UE applies the UL beam direction or spatial filter IE to the PUCCH resources configured with the indicated PUCCH resource group ID.

If the MAC-CE is received with an UL BWP ID, the UL beam direction or spatial filter IE is applied to the said PUCCH resources configured only within the indicated UL BWP.

According to an embodiment, the method may further comprise receiving, from a network node, a higher layer configuration of at least one downlink RS, as a pathloss reference in an IE containing at least the following parameters: an ID unique for the pathloss reference RS and an ID of a DL RS; and receiving, a MAC-CE message, from the network node, containing the ID of at least one said pathloss reference RS IE or the ID of at least one ‘PUCCH-PathlossReferenceRS’ according to 3GPP Release 15, and a CORESET ID or a CORESET group ID or a PUCCH resource group ID; and using the DL RS configured in the pathloss reference RS indicated in the MAC-CE message to derive a pathloss factor for calculating of a transmit power for an UL transmission of a group of PUCCH resources associated via higher layer configuration with CORESET ID or CORESET group or PUCCH resource group indicated in the MAC-CE message or to any PUCCH resource(s) indicated via the PUCCH resource indicator field by PDCCH(s) transmitted on the CORESET or on the CORESET(s) belonging to the CORESET group indicated in the MAC-CE message.

If the MAC-CE is received with an UL BWP ID, the DL RS configured in the pathloss reference RS indicated in the MAC-CE message is used to derive a pathloss factor for calculating of a transmit power for an UL transmission of said PUCCH resources that are configured in the indicated UL BWP.

According to an embodiment, a method performed by a UE comprising receiving, from a network node, an IE, via a higher layer, of one or more power control settings for a PUCCH, PUCCH-PC-setting, wherein a power control setting contains at least the following parameters: an ID unique for each power control setting IE, a closed loop power control index, a p0-PUCCH-ID and optionally the ID of a pathloss reference RS for PUCCH.

According to an embodiment, the method further comprises receiving, from the network node, in a MAC-CE message, at least the following parameters: a PUCCH-PC-setting ID and one or more PUCCH resource IDs; and applying the power control settings indicated by the PUCCH-PC-setting to PUCCH resource(s) indicated in the MAC-CE message to derive a transmit power for said PUCCH resources in an UL transmission.

According to an embodiment, the method further comprises receiving, from a network node, a higher layer configuration of at least one downlink RS as a pathloss reference in an IE containing at least the following parameters: an ID unique for the pathloss reference RS and the ID of a DL Reference Signal, RS or the ID of a CORESET; and when a PUSCH/PUCCH resource/SRS resource is configured/indicated with a pathloss reference RS IE, using the DL RS in the pathloss reference RS IE as a pathloss reference to derive the pathloss factor for the transmission of the said PUSCH/PUCCH resource/SRS resource, or using the DL RS configured with ‘qcl-TypeD’ in a TCI-state, indicated for the CORESET, as pathloss reference RS to derive the pathloss factor for the calculation of the transmit power for an UL transmission of the said PUSCH/PUCCH resource/SRS resource.

According to an embodiment, the method further comprises receiving, from the network node, in a MAC-CE message, at least the following parameters: a PUCCH-PC-setting ID, a pathloss reference RS ID or a ‘PUCCH-PathlossReferenceRS’ ID according to 3GPP Release 15 and one or more PUCCH resource IDs; and using the power control settings in the PUCCH-PC-setting and the indicated pathloss reference RS to derive the transmit power for the transmission of the PUCCH resources indicated in the MAC-CE message.

According to an embodiment, the method further comprises receiving, from the network node, via a higher layer, a configuration of an IE comprising a set of parameters used for configuration of an UL beam direction or the spatial filter to be used in a UL transmission; wherein the IE contains at least: an identifier, ID, unique to each IE and an ID of an UL reference signal, RS resource or a DL RS resource.

applying the UL beam direction or spatial filter IE for the transmission of one or more of the PUSCH, PUCCH resource(s) and/or SRS resource(s) which includes: transmission of the said PUSCH and/or PUCCH resource(s) and/or SRS resource(s) with the same spatial filter as the one used for the reception of the DL RS resource or the transmission of the UL RS resource contained in the UL beam direction or spatial filter IE.

According to an embodiment, the method may further comprise receiving from the network node, in a MAC-CE message, at least the following parameters: a PUCCH-PC-setting ID, one or more PUCCH resource IDs, a UL beam direction or spatial filter ID, and optionally, a pathloss reference RS ID or a ‘PUCCH-PathlossReferenceRS’ ID according to 3GPP Release 15.

If the MAC-CE message contains the pathloss reference RS ID or the ‘PUCCH-PathlossReferenceRS’ ID according to 3GPP Release 15, applying the indicated UL beam direction or spatial filter to the indicated PUCCH resources, and the power control settings in the indicated PUCCH-PC-setting and the pathloss reference RS indicated in the MAC-CE message are used to derive the transmit power for the transmission of the indicated PUCCH resources

If the MAC message is received without a pathloss reference RS ID or a ‘PUCCH-PathlossReferenceRS’ ID, applying the indicated UL beam direction or spatial filter and the power control settings indicated in ‘PUCCH-PC-setting’ to the indicated PUCCH resources, and obtaining the pathloss reference RS for the derivation of the pathloss factor for the transmission of the indicated PUCCH resources from one of the following:
the pathloss reference RS configured in the PUCCH-PC-setting indicated in the MAC-CE message, or
the DL RS configured in the UL beam direction or spatial filter IE indicated in the MAC-CE message, or

when the indicated UL beam direction or spatial filter IE is configured with a CORESET ID, the DL RS configured with ‘qcl-typeD’ in the TCI-state of the said CORESET.

If both the MAC-CE message and the ‘PUCCH-PC-setting’ indicated in the MAC-CE message indicate a pathloss reference RS, the UE uses the pathloss reference RS indicated in the MAC-CE message in the derivation of the transmit power for the transmission of the indicated PUCCH resources.

According to an embodiment, the method further comprises a higher layer configuration of a grouping/association of PUCCH resources:

using CORESET ID values or CORESET group ID values, or by using a PUCCH resource group identifier, PUCCH resource group ID, that is derived from the transmit/receive point (TRP) the PUCCH resources are associated with.

According to an embodiment, the method may further comprise receiving, from the network node, a MAC-CE message, containing at least the following parameters: a PUCCH-PC-setting ID and a CORESET ID or CORESET group ID or a PUCCH resource group ID. When the UE receives the MAC-CE message, the UE applies the power control settings indicated by the PUCCH-PC-setting to the PUCCH resource(s) associated via higher layer configuration with the indicated CORESET or CORESET group or PUCCH resource group.

According to an embodiment, the method may further comprise receiving from the network node, in a MAC-CE message, at least the following parameters: a PUCCH-PC-setting ID, a pathloss reference RS ID or a ‘PUCCH-PathlossReferenceRS’ ID according to 3GPP Release 15, and a CORESET ID or a CORESET group ID or a PUCCH resource group ID.

When the UE receives the MAC-CE message, the UE uses the power control settings in the PUCCH-PC-setting and the indicated pathloss reference RS assumption for the transmission of the PUCCH resources associated via higher layer configuration with the indicated CORESET or CORESET group or PUCCH resource group, if the ‘PUCCH-PC-setting’ indicated in the MAC-CE message is configured with a pathloss reference RS, the UE ignores it to use the pathloss reference RS indicated in the MAC-CE message to derive the pathloss factor for the transmission of the said PUCCH resources.

According to an embodiment, the method may further comprise receiving from the network node, in a MAC-CE message, at least the following parameters: a ‘PUCCH-PC-setting’ ID, a UL beam direction or spatial filter ID, a CORESET ID or a CORESET group ID or a PUCCH resource group ID, and optionally, a pathloss reference RS ID or the ‘PUCCH-PathlossReferenceRS’ ID according to 3GPP Release 15.

When the UE receives said MAC-CE message with a pathloss reference RS ID or a ‘PUCCH-PathlossReferenceRS’ ID according to 3GPP Release 15, the UE applies the indicated UL beam direction or spatial filter to the indicated PUCCH resources, and the power control settings from the indicated PUCCH-PC-setting and the indicated pathloss reference RS are used to derive the transmit power for the transmission of the PUCCH resource(s) associated via higher layer configuration with the indicated CORESET or CORESET group or PUCCH resource group.

According to an embodiment, if the MAC message is received without a pathloss reference RS ID or a ‘PUCCH-PathlossReferenceRS’ ID according to 3GPP Release 15, applying the indicated UL beam direction or spatial filter and the power control settings indicated in ‘PUCCH-PC-setting’ to the said PUCCH resources, and obtaining the pathloss reference RS for the derivation of the pathloss factor for the transmission of the said PUCCH resources from one of the following:
the pathloss reference RS configured in the PUCCH-PC-setting indicated in the MAC-CE message, or
the DL RS configured in the UL beam direction or spatial filter IE indicated in the MAC-CE message, or
when the MAC-CE message contains a CORESET ID, the DL RS configured with ‘qcl-typeD’ in the TCI-state of the indicated CORESET, or
when the MAC-CE message contains a CORESET group ID, the DL RS configured with ‘qcl-typeD’ in the TCI-state of one of the CORESETs in the indicated CORESET group.

According to another embodiment, a method performed by a UE comprising using the spatial filter used for the reception of the PDCCH(s) on a CORESET for the transmission of PUCCH resource(s) indicated in the PUCCH resource indicator field of the PDCCH(s) transmitted on the CORESET.

According to another embodiment, the method may further comprise using the spatial filter used for the reception of the PDCCH(s) on a CORESET for the transmission of the PUCCH resource(s) indicated in the PUCCH resource indicator field of the PDCCH(s) transmitted on the CORESET, when the PUCCH resource(s) is (are) not configured/indicated with a spatial filter/spatial relation information.

According to another embodiment, the method may further comprise receiving, from a network node, a higher layer parameter that indicates whether the spatial filter used by the UE for the reception of the PDCCH(s) on a CORESET is used for the transmission of the PUCCH resource(s) indicated in the PUCCH resource indicator field of the PDCCH(s) transmitted on the CORESET.

According to another embodiment, a method performed by a UE comprising using the spatial filter used for the reception of a PDSCH for the transmission of the PUCCH resource(s) that carry the HARQ ACK/NACK for the PDSCH.

According to another embodiment, the method may further comprise using the spatial filter used for the reception of a PDSCH for the transmission of the PUCCH resource(s) that carry the HARQ ACK/NACK for the PDSCH, when the PUCCH resource(s) is (are) not configured/indicated with a spatial filter/spatial relation information.

According to another embodiment, the method may further comprise receiving, from a network node, a higher layer parameter that indicates whether the spatial filter used by the UE for the reception of a PDSCH is used for the transmission of the PUCCH resource(s) that carry the HARQ ACK/NACK for the PDSCH.

According to another embodiment, a method performed by a UE comprising using the DL RS configured with ‘qcl-TypeD’ in the TCI-state of a CORESET to derive the pathloss factor for the calculation of the transmit power for an UL transmission of the PUCCH resource(s) indicated by the PUCCH resource indicator field in the PDCCH(s) transmitted on the CORESET.

According to another embodiment, the method may further comprise using the DL RS configured with ‘qcl-TypeD’ in the TCI-state of a CORESET to derive the pathloss factor for the calculation of the transmit power for an UL transmission of the PUCCH resource(s) indicated by the PUCCH resource indicator field in the PDCCH(s) transmitted on the CORESET, when there is no configuration/indication of pathloss reference RS(s) for the PUCCH resource(s).

According to another embodiment, the method may further comprise receiving, from a network node, a higher layer parameter that indicates whether the UE shall use the DL RS configured with ‘qcl-TypeD’ in the TCI-state of a CORESET to derive the pathloss factor for the calculation of the transmit power for an UL transmission of the PUCCH resources indicated by the PUCCH resource indicator field in the PDCCH(s) transmitted on the CORESET.

According to another embodiment, a method performed by a UE comprising using the DL RS configured with ‘qcl-TypeD’ in the TCI-state of a PDSCH to derive the pathloss factor for the calculation of the transmit power for an UL transmission of the PUCCH resource(s) that carries the HARQ ACK(s)/NACK(s) for the PDSCH.

According to another embodiment, the method may further comprise using the DL RS configured with ‘qcl-TypeD’ in the TCI-state of a PDSCH to derive the pathloss factor for the calculation of the transmit power for an UL transmission of the PUCCH resource(s) that carries the HARQ ACK(s)/NACK(s) for the PDSCH, when there is no configuration/indication of pathloss reference RS(s) for the PUCCH resource(s).

According to another embodiment, the method may further comprise receiving, from a network node, a higher layer parameter that indicates whether the UE shall use the DL RS configured with ‘qcl-TypeD’ in the TCI-state of a PDSCH to derive the pathloss factor for the calculation of the transmit power for an UL transmission of the PUCCH resource that carries the HARQ ACK(s)/NACK(s) for the PDSCH.

According to another embodiment, a method performed by a UE comprising
receiving, from a network node, a higher layer configuration of at least one DL reference signal, RS, as a pathloss reference for SRS in an IE containing at least the following parameters: an ID unique for the pathloss reference RS and an ID of a DL RS; and
using said pathloss reference RSs in the configuration of the power control setting(s) and/or in the indication of the pathloss reference for SRS resource(s).

The method further comprises: receiving a MAC-CE message, from the network node, containing at least a pathloss reference RS ID and ID(s) of one or more SRS resources or SRS resource sets, and using the DL RS configured in the pathloss reference RS IE to derive a pathloss factor for calculating transmit power of UL transmission of the indicated SRS resources or all the SRS resources in the indicated SRS resource sets.

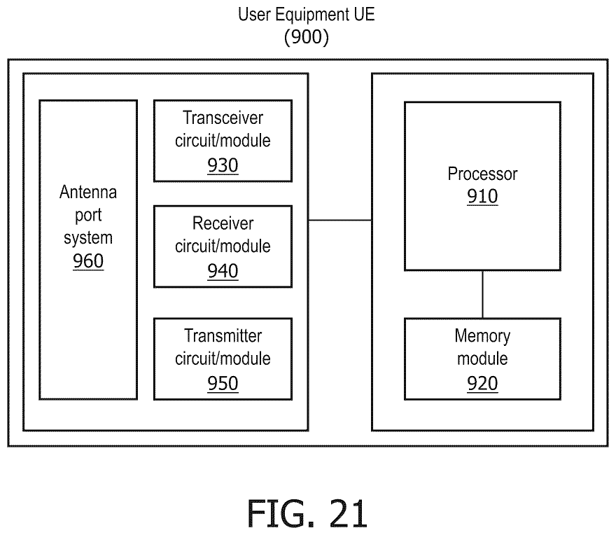

In order to perform the previously described process or method steps, there is also provided a UE. FIG. 21 illustrates a block diagram depicting a UE. The UE 900 comprises a processor 910 or processing circuit or a processing module or a processor or means 910; a receiver circuit or receiver module 940; a transmitter circuit or transmitter module 950; a memory module 920 a transceiver circuit or transceiver module 930 which may include the transmitter circuit 950 and the receiver circuit 840. The UE 900 further comprises an antenna system 960 which includes antenna circuitry for transmitting and receiving signals to/from at least the UE. The antenna system may employ beamforming as previously described.

The UE 900 may belong to any radio access technology including 4G or LTE, LTE-A, 5G, etc. that support beamforming technology. The UE comprising a processor and a memory contains instructions executable by the processor, whereby the UE is operative to perform any on of the subject-matter of claims 1-53.

Details on the functions and operations performed by the UE have already been described and need not be repeated.

There is also provided a method performed by a network node (e.g. a gNB) or any suitable network entity. Details of the actions performed by the network node or gNB or any suitable network entity for configuring the UE according to the previously described embodiment have already been presented.

The network node or gNB comprises a processor or processing circuit or a processing module or a processor or means; a receiver circuit or receiver module; a transmitter circuit or transmitter module; a memory module a transceiver circuit or transceiver module which may include the transmitter circuit and the receiver circuit. The gNB further comprises an antenna system which includes antenna circuitry for transmitting and receiving/transmitting signals to/from at least the UE. The antenna system employs beamforming as previously described. The gNB may operate in any radio access technology including 2G, 3G, 4G or LTE, LTE-A, 5G, WLAN, and WiMax etc. that support beamforming technology.

The processing module/circuit includes a processor, microprocessor, an application specific integrated circuit (ASIC), field programmable gate array (FPGA), or the like, and may be referred to as the “processor.” The processor controls the operation of the gNB and its components. Memory (circuit or module) includes a random access memory (RAM), a read only memory (ROM), and/or another type of memory to store data and instructions that may be used by processor. In general, it will be understood that the gNB in one or more embodiments includes fixed or programmed circuitry that is configured to carry out the operations in any of the embodiments disclosed herein.

In at least one such example, the gNB includes a microprocessor, microcontroller, DSP, ASIC, FPGA, or other processing circuitry that is configured to execute computer program instructions from a computer program stored in a non-transitory computer-readable medium that is in, or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure. Further, it will be appreciated that the gNB may comprise additional components.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation. The embodiments herein may be applied in any wireless systems including LTE or 4G, LTE-A (or LTE-Advanced), 5G, WiMAX, WiFi, satellite communications, TV broadcasting etc. that may employ beamforming technology.

### REFERENCES

[1] 3GPP TS 38.211
[2] 3GPP TS 38.212
[3] 3GPP TS 38.213
[4] 3GPP TS 38.214
[5] 3GPP TS 38.321
[6] 3GPP TS 38.331
[7] 3GPP TS 38.101-1
[8] 3GPP TS 38.101-2

1. A method performed by a user equipment (UE) in a network comprising:
receiving, from a network node, via a higher layer than a Medium Access Control (MAC) layer, a Spatial Filter Information Element (SF-IE), and a Power Information Element (P-IE),
wherein the P-IE comprises a set of power control parameters used for configuring an uplink (UL) power control to be used in a UL transmission;
wherein the SF-IE comprises a set of parameters used for configuring an UL spatial filter to be used in the UL transmission;
wherein the SF-IE is distinct from the P-IE;
wherein the SF-IE comprises:
an SF-IE identifier unique to the SF-IE, and
an identifier of an SF reference (SF-Ref); and
wherein the SF-Ref indicates a reference spatial filter;
receiving a first MAC Control Element (MAC-CE) message;
wherein the first MAC-CE message comprises:
an identifier of the UL transmission (UL-ID), and
the SF-IE identifier; and
applying the reference spatial filter indicated by the SF-REF in the SF-IE as the UL spatial filter for the UL transmission.

2. The method of claim 1, further comprising:
receiving a second MAC Control Element (MAC-CE) message;
wherein the second MAC-CE message comprises:
an identifier of the UL transmission (UL-ID), and
the P-IE identifier; and
applying the power control parameters indicated by the P-IE as the UL power control for the UL transmission.

3. The method of claim 1, wherein the SF-Ref comprises one of: a UL resource or a Down-Link (DL) resource.

4. The method of claim 3, wherein the at least one UL resource or DL resource comprises at least one of:
a Channel State Information Reference Signal (CSI-RS) resource,
a Sounding Reference Signal (SRS) resource, and
a Synchronization Signal Block (SSB).

5. The method of claim 1, wherein the UL transmission comprises at least one of:
a Sounding Reference Signal (SRS),
a Physical Uplink Shared Channel (PUSCH), and
a Physical Uplink Control Channel (PUCCH).

6. A device comprising:
a processor circuit and a memory circuit, wherein the memory is arranged to store instructions for the processor circuit,
wherein the processor circuit is arranged to receive, from a network node, via a higher layer than a Medium Access Control (MAC) layer, a Spatial Filter Information Element (SF-IE), and a Power Information Element (P-IE),
wherein the P-IE comprises a set of power control parameters used for configuring an uplink power control to be used in a UL transmission;
wherein the SF-IE comprises a set of parameters used for configuring an uplink (UL) spatial filter to be used in the UL transmission;
wherein the SF-IE is distinct from the P-IE;
wherein the SF-IE comprises:
an SF-IE identifier unique to the SF-IE, and
an identifier of an SF reference (SF-Ref); and
wherein the SF-Ref indicates a reference spatial filter;
wherein the processor circuit is arranged to receive a first MAC Control Element (MAC-CE) message;
wherein the first MAC-CE message comprises:
an identifier of the UL transmission (UL-ID), and
the SF-IE identifier; and
wherein the processor circuit is arranged to apply the reference spatial filter indicated by the SF-REF in the SF-IE as the UL spatial filter for the UL transmission.

7. The device of claim 6,
wherein the processor circuit is arranged to receive a second MAC Control Element (MAC-CE) message;
wherein the second MAC-CE message comprises:
an identifier of the UL transmission (UL-ID), and
the P-IE identifier; and
wherein the processor circuit is arranged to apply the power control parameters indicated by the P-IE as the UL power control for the UL transmission.

8. The device of claim 6, wherein the SF-Ref comprises one of: a UL resource or a Down-Link (DL) resource.

9. The device of claim 8, wherein the at least one UL resource or DL resource comprises at least one of:
a Channel State Information Reference Signal (CSI-RS) resource,
a Sounding Reference Signal (SRS) resource, and
a Synchronization Signal Block (SSB).

10. The device of claim 6, wherein the UL transmission comprises at least one of:
a Sounding Reference Signal (SRS),
a Physical Uplink Shared Channel (PUSCH), and
a Physical Uplink Control Channel (PUCCH).

11. A method performed by a network node in a network comprising:
transmitting, via a higher layer than a Medium Access Control (MAC) layer, a Spatial Filter Information Element (SF-IE), and a Power Information Element (P-IE) to a User Equipment (UE),
wherein the P-IE comprises a set of power control parameters used for configuring an uplink power control to be used in a UL transmission by the UE;
wherein the SF-IE comprises a set of parameters used for configuring an uplink (UL) spatial filter to be used in the UL transmission by the UE;
wherein the SF-IE is distinct from the P-IE;
wherein the SF-IE comprises:
an SF-IE identifier unique to the SF-IE, and
an identifier of an SF reference (SF-Ref); and
wherein the SF-Ref indicates a reference spatial filter;
subsequently transmitting a first MAC Control Element (MAC-CE) message;
wherein the first MAC-CE message comprises:
an identifier of the UL transmission (UL-ID),
the SF-IE identifier, and
an instruction to the UE to apply the reference spatial filter indicated by the SF-REF in the SF-IE as the UL spatial filter for the UL transmission identified by the UL-ID.

12. The method of claim 11, comprising:
transmitting a second MAC Control Element (MAC-CE) message;
wherein the second MAC-CE message comprises:
an identifier of the UL transmission (UL-ID),
the P-IE identifier, and
an other instruction to the UE to apply the power control parameters indicated by the P-IE as the UL power control for the UL transmission identified by the UL-ID.

13. The method of claim 11, wherein the SF-Ref comprises one of: a UL resource or a Down-Link (DL) resource.

14. The method of claim 13, wherein the at least one UL resource or DL resource comprises at least one of:
a Channel State Information Reference Signal (CSI-RS) resource,
a Sounding Reference Signal (SRS) resource, and
a Synchronization Signal Block (SSB).

15. The method of claim 11, wherein the UL transmission comprises at least one of:
a Sounding Reference Signal (SRS) transmission,
a Physical Uplink Shared Channel (PUSCH) transmission, and
a Physical Uplink Control Channel (PUCCH) transmission.

16. A device comprising:
a processor circuit and a memory circuit, wherein the memory is arranged to store instructions for the processor circuit,
wherein the processor circuit is arranged to transmit, via a higher layer than a Medium Access Control (MAC) layer, a Spatial Filter Information Element (SF-IE), and a Power Information Element (P-IE) to a User Equipment (UE),
wherein the P-IE comprises a set of power control parameters used for configuring an uplink power control to be used in a UL transmission by the UE;
wherein the SF-IE comprises a set of parameters used for configuring an uplink (UL) spatial filter to be used in the UL transmission by the UE;
wherein the SF-IE is distinct from the P-IE;
wherein the SF-IE comprises:
an SF-IE identifier unique to the SF-IE, and
an identifier of an SF reference (SF-Ref); and
wherein the SF-Ref indicates a reference spatial filter;
wherein the processor circuit is arranged to transmit a first MAC Control Element (MAC-CE) message;
wherein the first MAC-CE message comprises:
an identifier of the UL transmission (UL-ID),
the SF-IE identifier, and
an instruction to the UE to apply the reference spatial filter indicated by the SF-REF in the SF-IE as the UL spatial filter for the UL transmission identified by the UL-ID.

17. The device of claim 16,
wherein the processor circuit is arranged to transmit a second MAC Control Element (MAC-CE) message;
wherein the second MAC-CE message comprises:
an identifier of the UL transmission (UL-ID),
the P-IE identifier, and
an other instruction to the UE to apply the power control parameters indicated by the P-IE as the UL power control for the UL transmission identified by the UL-ID.

18. The device of claim 16, wherein the SF-Ref comprises one of: a UL resource or a Down-Link (DL) resource.

19. The device of claim 18, wherein the at least one UL resource or DL resource comprises at least one of:
a Channel State Information Reference Signal (CSI-RS) resource,
a Sounding Reference Signal (SRS) resource, and
a Synchronization Signal Block (SSB).

20. The device of claim 16, wherein the UL transmission comprises at least one of:
a Sounding Reference Signal (SRS) transmission,
a Physical Uplink Shared Channel (PUSCH) transmission, and
a Physical Uplink Control Channel (PUCCH) transmission.

21. A method performed by a user equipment (UE) in a network, wherein the UE comprises a Physical Downlink Control Channel (PDCCH), a Physical Downlink Shared Channel (PDSCH), a Physical Uplink Control Channel (PUCCH), and a Physical Uplink Shared Channel (PUSCH), the method comprising:
receiving, from a network node, a Control Resource Set Identifier (CORESET ID) to be used for receiving transmissions on the PDCCH,
wherein the CORESET ID identifies a CORESET comprising a first beam direction to be used for receiving the transmissions on the PDCCH;
applying the CORESET to the PDCCH of the UE to configure the PDCCH to receive transmissions on the PDCCH using the first beam direction;
receiving, from the network node, via a Medium Access Control (MAC) layer, a first Control Element (first MAC-CE),
wherein the first MAC-CE instructs the UE to use the CORESET of the PDCCH for transmissions on the PUCCH;
applying the CORESET to the PUCCH of the UE to configure the PUCCH to transmit transmissions on the PUCCH using the first beam direction indicated in the CORESET of the PDCCH;
receiving, from the network node, a second MAC-CE,
wherein the second MAC-CE instructs the UE to modify the CORESET to use a second beam direction for receiving subsequent PDCCH transmissions; and
applying the modified CORESET to the PDCCH of the UE to configure the PDCCH to receive subsequent transmissions on the PDCCH using the second beam direction in response to the second MAC-CE, and
applying the modified CORESET to the PUCCH of the UE to configure the PUCCH to transmit subsequent transmissions on the PUCCH using the second beam direction in response to the second MAC-CE.

22. The method of claim 21, further comprising:
receiving, from the network node, a PDCCH message that instructs the UE to use the CORESET of the PDCCH for transmissions on the PUSCH;
applying the CORESET to the PUSCH of the UE to configure the PUSCH to transmit subsequent transmissions on the PUCCH using the first beam direction, and
in response to the second MAC-CE:
applying the modified CORESET to the PUSCH of the UE to configure the PUCCH to transmit subsequent transmissions on the PUCCH using the second beam direction.

23. The method of claim 21, wherein the first MAC-CE instructs the UE to configure multiple PUCCH resources to use the CORESET of the PDCCH for transmissions to the network node.

24. The method of claim 21, wherein the first MAC-CE instructs the UE to configure the PUCCH resource to use the CORESET of the PDCCH for transmissions to the network node, by indicating that the PUCCH uses resources for transmitting Hybrid Automatic Repeat reQuest (HARQ) acknowledgements (ACKs) and negative acknowledgements (NACKs) for PDSCH transmissions from the network node.

25. A device comprising:
a processor circuit;
a memory circuit, wherein the memory is arranged to store instructions for the processor circuit;
a Physical Downlink Control Channel (PDCCH);
a Physical Downlink Shared Channel (PDSCH);
a Physical Uplink Control Channel (PUCCH); and
a Physical Uplink Shared Channel (PUSCH),
wherein the processor circuit is arranged to receive, from a network node, a Control Resource Set Identifier (CORESET ID) to be used for receiving transmissions on the PDCCH,
wherein the CORESET ID identifies a CORESET comprising a first beam direction to be used for receiving the transmissions on the PDCCH;
wherein the processor circuit is arranged to apply the CORESET to the PDCCH of the device to configure the PDCCH to receive transmissions on the PDCCH using the first beam direction;
wherein the processor circuit is arranged to receive, from the network node, via a Medium Access Control (MAC) layer, a first Control Element (first MAC-CE),
wherein the first MAC-CE instructs the device to use the CORESET of the PDCCH for transmissions on the PUCCH,
wherein the processor circuit is arranged to apply the CORESET to the PUCCH of the device to configure the PUCCH to transmit transmissions on the PUCCH using the first beam direction indicated in the CORESET of the PDCCH,
wherein the processor circuit is arranged to receive, from the network node, a second MAC-CE,
wherein the second MAC-CE instructs the device to modify the CORESET to use a second beam direction for receiving subsequent PDCCH transmissions; and
wherein the processor circuit is arranged to apply the modified CORESET to the PDCCH of the device to configure the PDCCH to receive subsequent transmissions on the PDCCH using the second beam direction in response to the second MAC-CE, and
wherein the processor circuit is arranged to apply the modified CORESET to the PUCCH of the device to configure the PUCCH to transmit subsequent transmissions on the PUCCH using the second beam direction in response to the second MAC-CE.

26. The method of claim 25,
wherein the processor circuit is arranged to receive, from the network node, a PDCCH message that instructs the device to use the CORESET of the PDCCH for transmissions on the PUSCH;
wherein the processor circuit is arranged to apply the CORESET to the PUSCH of the device to configure the PUSCH to transmit subsequent transmissions on the PUCCH using the first beam direction, and
wherein the processor circuit is arranged to apply the modified CORESET to the PUSCH of the device to configure the PUCCH to transmit subsequent transmissions on the PUCCH using the second beam direction in response to the second MAC-CE.

27. The method of claim 25, wherein the first MAC-CE instructs the device to configure multiple PUCCH resources to use the CORESET of the PDCCH for transmissions to the network node.

28. The method of claim 25, wherein the first MAC-CE instructs the device to configure the PUCCH resource to use the CORESET of the PDCCH for transmissions to the network node, by indicating that the PUCCH uses resources for transmitting Hybrid Automatic Repeat reQuest (HARQ) acknowledgements (ACKs) and negative acknowledgements (NACKs) for PDSCH transmissions from the network node.

29. A method performed by network node in a network, wherein the network comprises a Physical Downlink Control Channel (PDCCH), a Physical Downlink Shared Channel (PDSCH), a Physical Uplink Control Channel (PUCCH), and a Physical Uplink Shared Channel (PUSCH), the method comprising:
transmitting, to a User Equipment (UE), an Uplink Spatial Filter Information Element (UL-SF),
wherein the UL-SF comprises a Control Resource Set Identifier (CORESET ID) to be used for receiving transmissions from the network node on the PDCCH,
wherein the CORESET ID identifies a CORESET comprising a first beam direction to be used for receiving the transmissions from the network node on the PDCCH
wherein the UL-SF comprises an instruction to the UE to apply the CORESET to the PDCCH of the UE to configure the PDCCH to receive transmissions from the network node on the PDCCH using the first beam direction;
transmitting, to the UE, via a Medium Access Control (MAC) layer, a first Control Element (first MAC-CE),
wherein the first MAC-CE instructs the UE to apply the CORESET to the PUCCH of the UE to configure the PUCCH to transmit transmissions on the PUCCH using the first beam direction indicated in the CORESET of the PDCCH;
transmitting, to the UE, a second MAC-CE,
wherein the second MAC-CE modifies the CORESET to use a second beam direction for receiving subsequent PDCCH transmissions; and
wherein the second MAC-CE instructs the UE to apply the modified CORESET to the PDCCH of the UE to configure the PDCCH to receive subsequent transmissions on the PDCCH using the second beam direction, and
wherein the second MAC-CE instructs the UE to apply the modified CORESET to the PUCCH of the UE to configure the PUCCH to transmit subsequent transmissions from the UE on the PUCCH using the second beam direction.

30. The method of claim 29, further comprising:
transmitting, to the UE, a PDCCH message,
wherein the PDCCH message instructs the UE to apply the CORESET to the PUSCH of the UE to configure the PUSCH to transmit subsequent transmissions from the UE on the PUCCH using the first beam direction, and
wherein, the second MAC-CE instructs the UE to apply the modified CORESET to the PUSCH of the UE to configure the PUCCH to transmit subsequent transmissions on the PUCCH using the second beam direction.

31. The method of claim 29, wherein the first MAC-CE instructs the UE to configure multiple PUCCH resources to use the CORESET of the PDCCH for transmissions to the network node.

32. The method of claim 29, wherein the first MAC-CE instructs the UE to configure the PUCCH resource to use the CORESET of the PDCCH for transmissions to the network node by indicating that the PUCCH uses resources for transmitting Hybrid Automatic Repeat reQuest (HARQ) acknowledgements (ACKs) and negative acknowledgements (NACKs) for PDSCH transmissions from the network node.

33. A device comprising:
a processor circuit and a memory circuit, wherein the memory is arranged to store instructions for the processor circuit,
wherein the device is a portion of a network,
wherein the network comprises:
a Physical Downlink Control Channel (PDCCH);
a Physical Downlink Shared Channel (PDSCH);
a Physical Uplink Control Channel (PUCCH); and
a Physical Uplink Shared Channel (PUSCH),
wherein the processor circuit is arranged to transmit, to a User Equipment (UE), an Uplink Spatial Filter Information Element (UL-SF),
wherein the UL-SF comprises a Control Resource Set Identifier (CORESET ID) to be used for receiving transmissions from the network node on the PDCCH,
wherein the CORESET ID identifies a CORESET comprising a first beam direction to be used for receiving the transmissions from the network node on the PDCCH
wherein the UL-SF comprises an instruction to the UE to apply the CORESET to the PDCCH of the UE to configure the PDCCH to receive transmissions from the network node on the PDCCH using the first beam direction;
wherein the processor circuit is arranged to transmit, to the UE, via a Medium Access Control (MAC) layer, a first Control Element (first MAC-CE),
wherein the first MAC-CE instructs the UE to apply the CORESET to the PUCCH of the UE to configure the PUCCH to transmit transmissions on the PUCCH using the first beam direction indicated in the CORESET of the PDCCH;
wherein the processor circuit is arranged to transmit, to the UE, a second MAC-CE,
wherein the second MAC-CE modifies the CORESET to use a second beam direction for receiving subsequent PDCCH transmissions; and
wherein the second MAC-CE instructs the UE to apply the modified CORESET to the PDCCH of the UE to configure the PDCCH to receive subsequent transmissions on the PDCCH using the second beam direction, and
wherein the second MAC-CE instructs the UE to apply the modified CORESET to the PUCCH of the UE to configure the PUCCH to transmit subsequent transmissions from the UE on the PUCCH using the second beam direction.

34. The device of claim 33,
wherein the processor circuit is arranged to transmit, to the UE, a PDCCH message,
wherein the PDCCH message instructs the UE to apply the CORESET to the PUSCH of the UE to configure the PUSCH to transmit subsequent transmissions from the UE on the PUCCH using the first beam direction, and
wherein, the second MAC-CE instructs the UE to apply the modified CORESET to the PUSCH of the UE to configure the PUCCH to transmit subsequent transmissions on the PUCCH using the second beam direction.

35. The device of claim 33, wherein the first MAC-CE instructs the UE to configure multiple PUCCH resources to use the CORESET of the PDCCH for transmissions to the network node.

36. The device of claim 33, wherein the first MAC-CE instructs the UE to configure the PUCCH resource to use the CORESET of the PDCCH for transmissions to the network node by indicating that the PUCCH uses resources for transmitting Hybrid Automatic Repeat reQuest (HARQ) acknowledgements (ACKs) and negative acknowledgements (NACKs) for PDSCH transmissions from the network node.
